(19) United States
(12) Patent Application Publication
(10) Pub. No.: US 2021/0350442 A1
(43) Pub. Date: Nov. 11, 2021

(54) DISTRIBUTED INVENTORY SYSTEM

(71) Applicant: Scott AMRON, Plainview, NY (US)

(72) Inventor: Scott AMRON, Plainview, NY (US)

(21) Appl. No.: 17/262,354

(22) PCT Filed: Jul. 22, 2019
(86) PCT No.: PCT/US2019/042869

§ 371 Date: Jan. 22, 2021

Related U.S. Application Data
(60) Provisional application No. 62/793,910, filed on Jan. 18, 2019.
(60) Provisional application No. 62/701,835, filed on Jul. 22, 2018.

(51) Int. Cl. G06Q 30/06; G06Q 10/08; G06Q 30/00; G06Q 30/02

(52) U.S. Cl. CPC G06Q 30/0633; G06Q 30/0202; G06Q 30/01; G06Q 10/087

(57) ABSTRACT

A system for asset control, the system includes processing circuitry; a memory including instructions that, when the system is in operation, configure the processing circuitry to: record, in an order history, a sale of an asset to a first consumer, the sale conducted between the first consumer and a retailer, the first consumer registered with a retail platform of the retailer; present an asset list to the first consumer, the asset list based on the order history and including a list of assets purchased from the retailer by the first consumer and corresponding current value of each asset; receive an indication from the first consumer to transfer the asset; determine a set of transfer options for the asset; present the set of transfer options to the first consumer; receive a selected transfer option from the set of transfer options; and conduct a transaction based on the selected transfer option.

### CLAIM OF PRIORITY

This patent application claims the benefit of priority to U.S. Provisional Patent Application Ser. No. 62/701,835, titled “END-OF-USE PRODUCT SUPPORT SYSTEM” and filed on Jul. 22, 2018, and also claims priority to U.S. Provisional Patent Application Ser. No. 62/793,910, titled “END-OF-USE CONSUMER PRODUCT SUPPORT SYSTEM” and filed on Jan. 18, 2019, the entirety of all are hereby incorporated by reference herein.

### TECHNICAL FIELD

Embodiments described herein generally relate to electronic asset management and more specifically to a distributed inventory system.

### BACKGROUND

Electronic asset tracking can involve many facets of recording asset lifecycle events. Such events can include creation, sourcing, warehousing, transportation, etc. Here, an asset, or item, is anything that is individually tracked. Thus, in an example, a computer is an item and a processor within the computer can be a second item.

Tracking items within a company is often performed via control systems of the company. Thus, a company may source components of the item and register them within a database when the components are delivered. The company can then update the database entry to indicate stages of, or completion of, the item's manufacture. Generally, the last thing the company tracks is delivery of the item to a customer following a sale. In an example, a company may maintain records of the item after delivery to, for example, address warranty issues.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment with a distributed inventory system, according to an embodiment.

FIG. 2 is an example of an item that is composed of other items, according to an embodiment.

FIG. 3 is a swim lane diagram illustrating interactions between a consumer, a retailer, and a third party, according to an embodiment.

FIG. 4 is a flowchart illustrating a method for asset control, according to an embodiment.

FIGS. 5, 6, and 7 are examples of user interfaces to interact with items, according to several embodiments.

FIG. 8 is an example of a method for a distributed inventory management system, according to an embodiment.

FIG. 9 illustrates an example webpage, displaying an optimized list of a customer's items and a command bar to aid the customer in selecting a specific item by noun, according to an embodiment.

FIG. 10 illustrates an example webpage, displaying all available end-of-use options on a single page for a selected item, according to an embodiment.

FIG. 11 is a block diagram illustrating an example of a machine upon which one or more embodiments may be implemented.

### DETAILED DESCRIPTION

Inventory systems are generally applied to items within a company's control, such as in warehouses, at a distributor, etc. Tracking items outside of the company's control is generally to promote good user experience, such as with warranty repair of defective items, facilitating item returns, etc. These user impact applications are growing. Specifically, consumer concern over the environmental impact of products as they age, as well as concern over the impact of producing new products has become an important consideration for consumers and some governments. For example, some regulators require a purveyor of goods to have a recycling program for the goods they sell.

To improve the user experience with items that the user no longer had a use for, a distributed inventory system can be used to track lifecycle events and facilitate responsible movement of the item to a more productive use or a safe disposal. Here, a manufacturer, or a retailer, may track items, or parts of those items, over an extended period after the item is sold to a user. The user may periodically inform the inventory management system of status change events of the item. The inventory manage system can then, using information about the item already stored in the inventory management system, facilitate movement of the item to a new use, or even a safe disposal.

An example use-case of the distributed inventory system may include its use at an online retailer. The retailer has product information from the manufacturer to, for example, produce a detailed listing for the item. Once the user purchases the item and it is delivered to the user, this product information is maintained by the retailer. At some later date the user may no longer have no use for the item. For example, say the user bought an electric drill for a home-improvement project to sell a house in order to take an extended trip to foreign lands. After the project is complete, the user no longer wants the drill (e.g., the user will not take it with them and does not have a place to store it). In this scenario, the user can inform the distributed inventory system that the user no longer wants the drill.

The distributed inventory system can use its information to facilitate movement of the drill by, for example, selling or trading it to another, arranging a recycler to retrieve the drill, or providing the user with instructions on how to safely dispose of the drill. In fact, the information used to originally list the item can largely be re-used to create a new listing (e.g., an auction listing) on behalf of the user. Thus, this process may be a simple as the user speaking into a smart speaker (e.g., connected to a virtual assistant), “I would like to sell my drill,” and the listing is created.

Several items are composed of parts that can have value on their own. For example, if, instead of moving, the user damaged the drill such that it no longer works. The user contacts the distributed inventory system and states “I would like to dispose of my drill.” The inventory management system can use its information to retrieve a parts list for the drill and find that the removable battery has an aftermarket value. The inventory management system can then prompt the user to confirm whether the user would like to sell the battery and, after confirming that the user would like to sell the battery, the distributed inventory system creates a listing for the battery in an electronic marketplace and also provides the user with the recycling center for the remainder of the drill.

Not only does the distributed inventory system described herein enable companies to meet ever changing and greater user demands for complete product lifecycle management, but it also creates an opportunity for a long-term and fruitful relationship between companies and users. Additional details and examples are provided below.

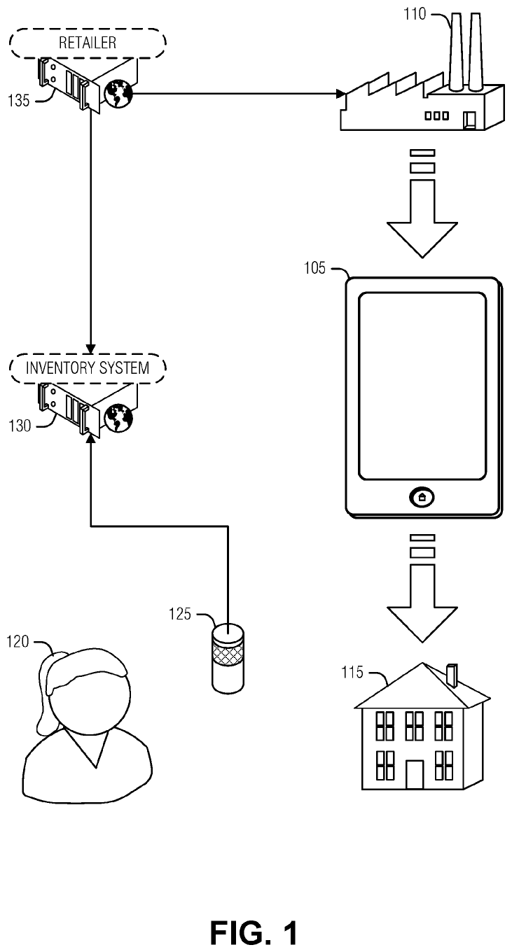

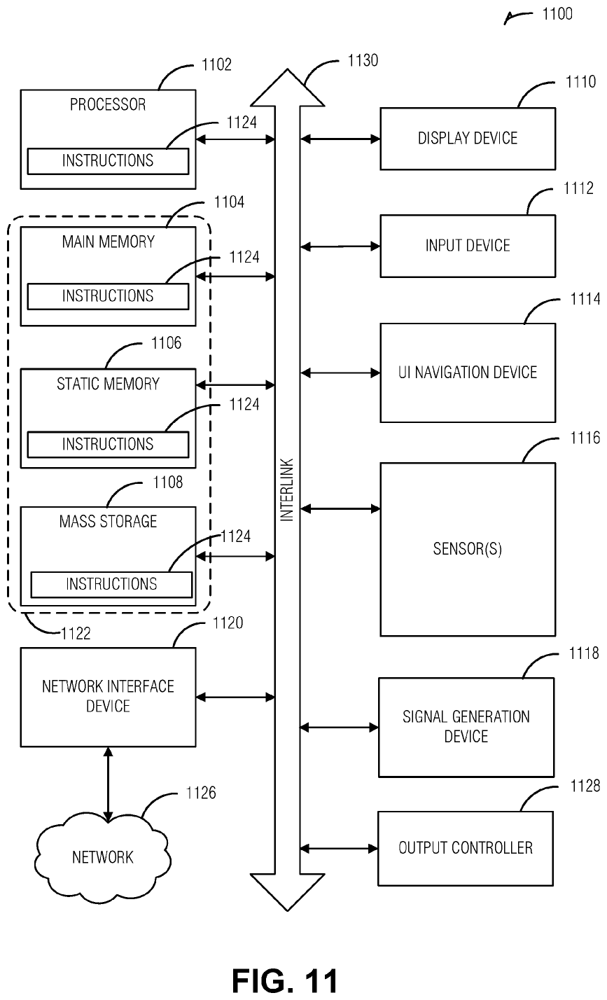

FIG. 1 illustrates an example of an environment with a distributed inventory system, according to an embodiment. As illustrated, a retailer system 135 maintains (e.g., creates, collects, stores, etc.) information about an item 105. The retailer system 135 is communicatively coupled, when in operation, to the retailer facility 110, such as a factory, warehouse, etc. This retailer facility 110 is an example of a first location for the item 105 as described below. The distributed inventory system 130, described below, and the retailer system 135 are computer systems implemented with appropriate hardware, such as that illustrated in FIG. 11 and described below.

When the user 120 purchases the item 105, the item is transferred from the first location 110 to a second location 115, such as the user's home. The distributed inventory system 130 is configured to obtain (e.g., request, receive, retrieve, etc.) the item information from the retailer system 135. Thus, the information obtained from a management system that corresponds to the first location. This correspondence refers to control. Thus, correspondence can occur based on location (e.g., the retailer system 135 is an inventory management system for a factory 110) or based on ownership. In an example, the item information can be collected from several sources. Thus, for example, the retailer system 135 can provide the items specifications (e.g., including parts), but additional item information can be obtained from a regulator (e.g., a government testing agency), or a third party (e.g., testing lab, consumer advocacy group, etc.).

In an example, the item 105 is a part in a second item. Part tracking can be very useful when it comes to re-selling, recycling, reusing, or disposing of a product. Generally, parts can be treated in the same way as the whole item. However, some additional applications may be used to the user 120 in this scenario, such as instructions on how to remove the part from the product. Additional examples are provided below with the discussion regarding facilitating item transfer to a third location.

The distributed inventory system 130 is configured to receive a status change event for the item 105. A status change event can be many different things, such as failure of the item 105 or a desire by the user 120 to be rid of the item 105. Thus, in an example, the status change event is an indication to sell the item 105. The user 120 can use a variety of techniques to provide the status change event to the distributed inventory system 130. For example, the distributed inventory system 130 can be configured to present a user interface (e.g., via a web site) to capture the status change event. In an example, the indication to sell the item is based on a voice command received at a smart speaker 125. Smart speakers can be a convenient starting point for the user 120 because, unless the item is internet or app capable, the user is unlikely to be at a device in which to enter the status change event. However, if the user 120 decides to sell an item, the user 120 can simply state, “RETAILER, I'd like to sell my guitar,” to the smart speaker 125, and the distributed inventory system 130 will receive the status change event.

In an example, the distributed inventory system 130 is configured to request a condition assessment in response to receiving the status change event. The condition assessment can be used for many purposes, such as assessing the value of the item 105 for resale, to assess whether parts of the item 105 are usable, or whether a dangerous condition exists (e.g., a battery has ruptured). The distributed inventory system 130 is also configured to receive a characteristic of the item in response to the condition assessment. Here, the characteristics is evidence of the item's condition—such as photographic, video, assessment by a laboratory, self-diagnostic output by the item 105, etc. evidence—or a characterization provided by the user 120—such as the item 105 is in “good,” “poor,” or “average” condition.

In an example, the condition assessment request includes instructions to capture at least one of an image or video of the item. Such instructions can include profiles of the item 105—such as a photograph of the front, top, and side of the item, techniques to use—such as a minimum resolution, distance from the camera to the object, etc., among other things. In an example, the instructions can be embodied in an application for a mobile device. The application is configured to instruct the user 120 on how the image of video should be captured. The application can include a workflow that the user 120 follows to complete the capture.

In an example, receiving the characteristic of the item includes receiving the image or video of the item and invoking an inference engine on the image or video to produce the characteristic. In this example, an inference engine is used to automatically create an assessment. Here, inference engine refers to any computer device that is trained to classify things, such as an artificial neural network, support vector machine, etc. Generally, the inference engine is trained with labeled training data for each of the possible output classifications. Thus, training data for a guitar would include as many different pictures of a guitar that are labeled whether the guitar is in good, fair, or poor condition. In an example, the inference engine is configured to accept verbal or textual information. Thus, if the user 120 characterizes the item 105 in fair condition, the inference engine can use this input in order to fine-tune its output.

In an example, the status change event includes an ambiguity. Such an ambiguity can arise if, for example, the user 120 is not specific enough when entering the status change event. For example, the user 120 may have several skateboards including a longboard the user 120 wants to get rid of. The user 120 states, “I'd like to donate my skateboard.” Here, there is not enough information for the distributed inventory system 130 to distinguish to which of the several skateboards the user 120 refers. Other ambiguities can include any variation between the content of the status change event and the item information such that the status change event matches several items, or the distributed inventory system 130 is unable to parse the status change event.

To resolve ambiguities, the distributed inventory system 130 is configured to select an inquiry from a set of inquiries to resolve the ambiguity and transmit the inquiry to an author of the status change event. The term author is used here because the status change event can come from a party other than the user 120. For example, the user 120 may have contacted another retailer to sell the item 105 and this second retailer is provided the status change event. However, in many cases, the user 120 is the author of the status change event.

The inquiry is a question, or set of questions, that reduce the number of possible meanings of the status change event. Thus, in the skateboard example, the inquiry can be, “Did you mean the longboard?” Then, the status change event can be updated with an answer from the author to resolve the ambiguity. In an example, the set of inquiries are voice prompts. This form of inquiry can work well in conjunction with the smart speaker 125 because the user has a consistent interaction to resolve the status change event entry.

Several techniques can be employed to select one or more inquiries to resolve the ambiguities. For example, set of inquiries can be selected by retrieving profile for the user 120 of the item 105. Here, the profile includes a set of items of the user. Characteristics of the user's items can be collected and a set of differentiating characteristics calculated. In an example, the calculation is performed by subtracting an intersection of characteristics across the items from each of the items. Thus, characteristics that are shared between two items are not included in the set of differentiating characteristics. In an example, a tolerance can be applied to determine whether characteristics are within the intersection. For example, if one item has the color characteristic “pink” and another has the characteristic “deep rose” they can be treated as the same value for the purposes of the intersection.

Once differentiating characteristics are identified, the set of inquiries can be filtered to remove inquiries that are not directed to the differentiating characteristics. In an example, the filtering maximizes a distance function between inquires. Thus, for example, while two inquiries can be directed to a differentiating characteristic, one can be filtered out if it is too close in kind to the other. This will help ensure that the fewest number of inquiries are used to resolve the ambiguity. Thus, for example, if the user 120 has multiple skateboards, asking for a brand or a color may resolve the ambiguity, but asking for both may be unnecessary to resolve which of two skateboards, for example, the user 120 intended for the status change event.

In an example, the status change event is notification that the item 105 is an accessory item for a second item of a user 120. This example is different than that illustrated in FIG. 1. Specifically, the item 105 in this example if a part of the product, such as a battery in a cordless drill, strings on a violin, a lens for a camera, that the user 120 may be interested in adding to the product. In this example, the distributed inventory system 130 is proactively interacting with the user 120 to potentially increase the user's enjoyment of a previous acquired product.

In an example, the status change event is notification that the item 105 has changed in value in a market. Here, the distributed inventory system 130 engages in market valuation for the item 105. The notification it sends to the user 120 can prompt the user 120 to sell, trade, or rent the item 105. This is an example of increase overall efficiency as, if the market demand for the item 105 is greater than the user's evaluation of the item's worth, the item 105 is moved to a third location (e.g., another user) where it will be used to greater effect. Such transactions can help reduce unnecessary production of products.

The distributed inventory system 130 is configured to update the information about the item 105 based on the status change event. In an example, updating the information about the item based on the status change event includes recording (e.g., changing or adding) the characteristic of the item as reported by the user. Here, the distributed inventory system 130 maintains an ongoing record of the item 105. This enables effective creation of listings, postings, or other activities to dispose of the item 105 in accordance with the user's wishes. Moreover, as the item 105 moves from user to user, company to company, etc., the distributed inventory system 130 maintains an ongoing record of the item 105. Such an audit capable trail can be used to ensure that the item 105 is ultimately disposed of properly.

The distributed inventory system 130 is configured to transmit an instruction to enable moving the item from the second location to a third location based on the updated information about the item 105. Such an instruction can include providing directions to the user 120. These directions can include manual for alternative uses of the item 105 (e.g., a cotton shirt can be cut to make handkerchiefs). The directions can include local recycling centers, or do-it-yourself disassembly steps to extract valuable parts from the item 105.

In an example, the instruction creates a listing for the item 105 in an electronic marketplace. Such a listing can include an auction listing, a used item listing, a listing to trade the item 105, or a listing to rent the item 105. Because the distributed inventory system 130 maintains the item information, much of the listing details are automatically populated, except, perhaps, for the price or terms (e.g., delivery terms, type of payment accepted, etc.). This enables a near effortless experience for the user 120, increasing the likelihood that the user 120 chooses to pass the item 105 were it may be better used.

In an example, to create the listing, the item 105 is correlated with a class of items. A market price can be calculated for the item based on the class of items. Here, the class of items can include fungible items or non-fungible items. For fungible items, the classification groups the items and can extract a market price by transactions for that group of items. For nonfungible items, or items that do not have much market data to establish a price, characteristics of the item 105 can be compared to items in the market. Thus, for example, a sculpture can be grouped with other sculptures, paintings, etc. based on subject matter, materials, size, or other characteristics. The number of characteristics used for the group can be gradually reduced until a threshold number of market transactions are found that meet the chosen characteristics. In an example, this market price is included in the listing when the listing is created.

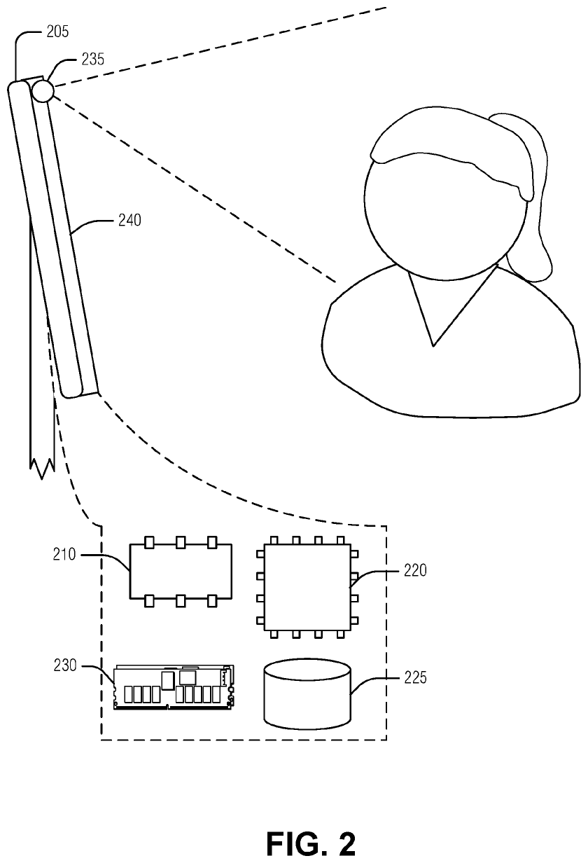

FIG. 2 is an example of an item 205 that is composed of other items, according to an embodiment. The example illustrated in FIG. 1 had an item that represented an entire product. However, as illustrated in FIG. 2, the item 205 can be composed of several other items that are tracked and disposed of similarly to the “whole product” item. For example, the if the item 205 is a computer, the item 205 can include a graphics processing unit 210 (GPU), a central processing unit 220 (CPU), non-volatile storage 225 (e.g., NAND flash, a hard drive, storage class memory, etc.), high-speed memory 230 (e.g., dynamic or static random access memory (DRAM) (SRAM)), a camera 235, and a display 240.

If the status change event is an indication that the user wants to get rid of the computer 205, the distributed inventory system can use the item information to recognize the collection of parts in the item 205. Suggestions as to selling or separately dispose of these component items can then be made. In an example, the reason for getting rid of the item 205 can be treated as an ambiguity. Thus, for example, if the user wants rid of the computer 205 because it can no longer play the latest game titles—which is resolved via an inquiry “why do you want to be rid of the computer?”—the distributed inventory management system can offer to replace the GPU 210, if possible. Otherwise, the user can be provided with instructions to disassemble the computer 205 in order to individually sell, trade, or recycle the components.

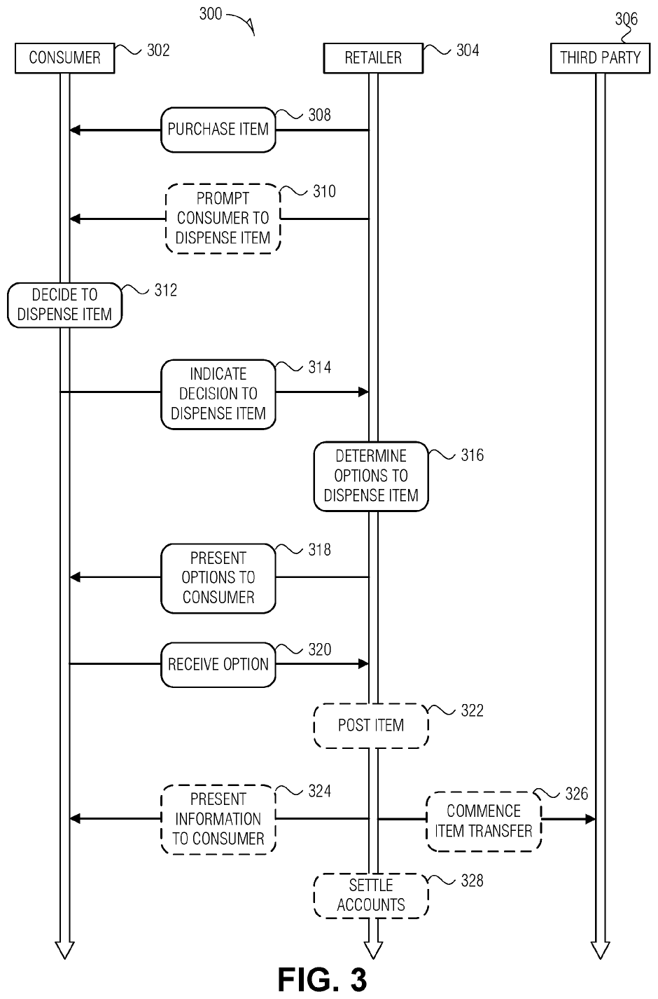

FIG. 3 is a swim lane diagram 300 illustrating interactions between a consumer 302, a retailer 304, and a third party 306, according to an embodiment. The consumer 302 may be a single person, a group of people (e.g., a family), a business, or other type of organization. The consumer 302 is able to purchase goods or services from the retailer 304. The purchase interactions may be performed in a physical store or online. Purchases are tracked by the retailer 304 in a purchase history that is unique to the consumer 302. The purchase history may include various aspects of the purchase transactions, such as date of purchase, name of item purchase, price paid, condition of item, and the like. As the consumer 302 interacts with the retailer 304 over several purchases, which may span for several months or years, the purchase history may become relative large (e.g., hundreds of items).

Through a regular lifecycle of use, the consumer 302 may decide to dispense of the purchased item (stage 312). For instance, after a year of use and a new version of the item is available for purchase, the consumer 302 may consider disposing of the item and purchasing the newer version.

In an alternative example, the retailer 304 may monitor the use of the item and prompt the consumer 302 to dispense the item (operation 310). For instance, the item may be a smart coffee maker that is connected through a home network to the Internet. The retailer 304 may obtain information about the use of the coffee maker and determine that the consumer 302 has not used it for some time. In this instance, the retailer 304 may suggest to the consumer 302 that the coffee maker could be disposed of in some manner. The prompt from the retailer 304 to the consumer 302 may be through various mechanisms including, but not limited to email, text message, or verbal prompt from a smart speaker. The prompt may be conditional based on various factors. For instance, the retailer 304 may only prompt the consumer 302 when a third party 306 has indicated an interest in the same or similar items. In this case, the consumer 302 may be prompted with something like “I see you haven't used your coffee maker for a while. If you like, you can sell this today for $35.” If the consumer 302 answers in the affirmative, then the coffee maker may be immediately sold. The proceeds from the sale may be credited to the consumer's account at the retailer 304 for immediate re-use. This may be based on the consumer's history with the retailer 304.

In any case, the consumer 302 decides to dispense of the item (stage 312) and indicates this decision to the retailer 304 (operation 314). The mode used to provide this indication may be through an interaction with a smart speaker, using a webpage, or using a mobile device application. For instance, the consumer 302 may speak into a smart speaker, “I want to sell my tv.” The initial indication of the consumer's decision may be followed up with other interactions to clarify the exact item that the consumer 302 wants to discard. Such follow-up interactions are needed when, for example, the consumer 302 has purchased several televisions from the retailer 304. Additional follow up questions may be used to determine the condition of the item (e.g., good condition or poor condition). Optionally, an image or video may be used to evaluate the condition of the item. For instance, the consumer 302 may use an app on a mobile phone to initiate the disposal of the item. The app may prompt the consumer 302 to capture an image or video of the item, and interface with a camera on the mobile phone to obtain the image or video. The app may analyze the image or video to determine the condition of the item. The app may interface with the retailer's platform (e.g., cloud service) to perform the analysis instead of performing image analysis locally at the mobile phone. The image or video may be marked as private such that the image or video is never posted online or available to other people—it is only used for the purposes of evaluating the condition of the item. In some implementations, the image or video may be immediately deleted after being used to evaluate condition.

In operation 316, the retailer 304 determines which options are available for the consumer 302 to dispense of the item. Options may include selling the item, giving the item away to another consumer in the retailer's system, donating the item to a charity, recycling the item, renting the item, lending the item, trading the item, repurposing the item, disposing the item, or reviving the item. Some of the options may not be available based on the type of item, its condition, market demand, location of the consumer 302, or other factors.

The options that are available for the item are presented to the consumer 302 in operation 318. These options may be ordered in a particular manner. For instance, in an example, the sell option is first, followed by the donate, recycle, and rent options. For each option presented, a value may be presented to indicate how much the consumer 302 may receive if the item is sold, rented, donated, or the like. For instance, the consumer 302 may want to dispose of the television and may be provided options indicating that a sale would net $35.00, a donation would be worth $20.00 as a tax deduction, and it may be rented for $5/month to another consumer on the retailer's platform. This allows the consumer 302 to decide which option is most interesting.

Values or worth of the item may be determined by analyzing sales or transfers of same or similar items. The sales or transfer information may be obtained from the retailer's platform (e.g., auction listing history information), or from a secondary source, such as another online auction service. Item values may be determined by depreciation tables, government valuation, third party data, or the like. The retailer platform may interface with one or more data sources to obtain item values. Values from multiple sources may be averaged.

Values for some transfers, such as renting, may be based on a set formula. For instance, renting may be set based on how long the third party 306 is willing to rent (e.g., a 12-month rent contract may be different than a 3-month rent contract), the type of item, the current value of the item, the renter's credit score or income, and the like. Using these parameters, a formula may be used to set the rent.

The consumer 302 selects an option and the option is communicated to the retailer 304 (operation 320). Based on the option selected, one or more responsive actions may be taken by the retailer 304. For instance, if the consumer 302 wants to sell, trade, lend, or rent the item, then a listing is created and the item is posted (operation 322). The third party 306 transacts to buy, trade, borrow, or rent the item. In some implementations, the listing may not be necessary if there are existing pre-orders available so that when the consumer 302 posts an interest to the sell, trade, lend, or rent the item, the intended transaction is matched with a pre-existing pre-order of the same or similar item. Such a matchmaking marketplace transaction reduces or eliminates marketplace friction and provides a clean and easy way for the consumer 302 to dispose of unwanted items.

People selling items on the retailer's platform may not be looking for “top dollar.” So, this creates an incentive for people to place bids to buy the item before the customer 302 decides to sell it. Lower prices, fast sales (instant sales), and other advantages are available to the customer 302 and third party 306. A goal the retailer's platform and service is to allow the customer 302 to salvage money from an item they don't want anymore while doing as little work as possible. The customer 302 wants instant sales and the money credited to their account immediately even if they get less than the market value. Sellers can get the credit or money instantly as soon as they say (or select) “Sell it.” This ease-of-use is value added that the customer 302 pays for in a reduced valuation of the sale item.

After the transaction is completed with the third party 306, the retailer 304 may commence the item transfer to the third party 306 (operation 326). This may include, for instance, providing a shipping label to the consumer 302 for the item, informing the third party 306 that the item has be purchased, or the like.

In another implementation, the retailer's platform provides a way for a user to sell a broken or incomplete item, and the retailer 304 may package or separately ship missing components. For instance, the consumer 302 may sell a television with a missing remote control. The retailer 304 may package and ship a compatible remote control to the third party 306. Replacement parts may include items such as remote controls, power cords, batteries, chargers, filters, covers, etc.

The retailer's platform may use the condition questions or photos, videos, etc. to determine if the item is missing parts. A check to see if the retailer sells the missing part(s) may be conducted. If the retailer sells the missing part, then an order may be placed and the part may be sent to the new owner so that it arrives around the same time as the used item. The buyer may be charge for the order of the replacement part(s) added.

If the consumer 302 wants to rent the item, then the item is listed for rent and the third party 306 may engage with the customer 302 to rent the item. By renting the item, the customer 302 is provided a why to find additional buyers/renters at a lower price point. In this way, the customer 302 is provided some income and funds which may incentivize a larger or more expensive initial purchase. For instance, the customer 302 may purchase a more expensive lawnmower than what they initially were to going to purchase with the knowledge that they can rent out the lawnmower and use the proceeds to offset the higher initial cost. The retailer 304 may make a commission or other fees on the rental and logistics (moving the equipment around, scheduling, billing, insurance, etc.).

If the consumer 302 wants to recycle or dispose of the item, the retailer 304 may provide information (operation 324) to the consumer 302. For instance, if the consumer 302 wants to recycle the item, then the retailer 304 may access a product database to determine the composition of the item (e.g., what recyclable parts are in the item), identify a recycler that is proximate to the consumer 302 and able to recycle the item (or parts of the item), and provide that information to the consumer 302. If a recycler is remote from the consumer 302 (e.g., in a different city), then the retailer 304 may provide a shipping label to the consumer 302 to ship the item to the remote recycler for recycling. If the item includes severable recyclable parts, then the retailer 304 may provide multiple recycling options or sites to the consumer 302. The consumer 302 may have to disassemble some of the item and separately ship the recyclable parts.

In operation 328, the retailer 304 settles accounts. In a sale, trade, lend, or rent transaction, this may include debiting the third party 306 and crediting the consumer 302. Setting accounts may include costs for shipping, packaging, or other transactional costs.

While FIG. 3 discusses interactions between a consumer 302 and a retailer 304, it is understood that other commercial entities may act in place of the retailer 304, such as a credit card company. The credit card company may have a similar purchase history available to provide transaction details to the consumer 302 and enable interactions between multiple consumers on the credit card company's platform to buy, sell, trade, donate, dispense, loan, pawn, or otherwise move goods. Providing this service to a credit card consumer promotes loyalty to the credit card company.

To obtain the purchase history from various retailers, vendors, merchants, or other service provides, the credit card company may request an itemized list for each purchase made on the corresponding credit card. Once the itemized list is obtained, the individual items may be identified for use in other processes described herein. A credit card may have a partnership or other relationship with a retailer and automatically obtain detailed sale information for each purchase on the credit card at the retailer. Such a relationship may be formed with the consent of the consumer or credit card holder.

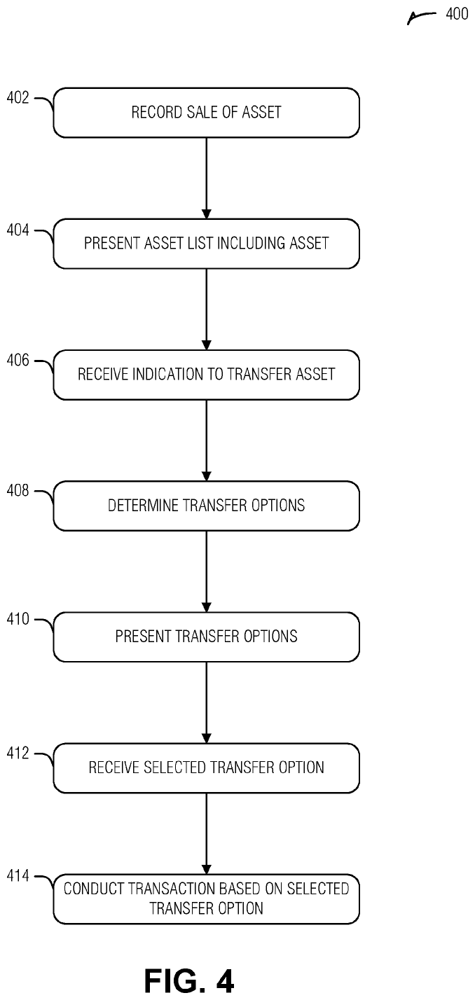

FIG. 4 is a flowchart illustrating a method 400 for asset control, according to an embodiment. At 402, a sale of an asset to a first consumer is recorded in an order history. The sale is conducted between the first consumer and a retailer, with the first consumer registered with a retail platform of the retailer.

At 404, an asset list is presented to the first consumer. The asset list is based on the order history and includes a list of assets purchased from the retailer by the first consumer and corresponding current value of each asset. In an embodiment, presenting the asset list comprises presenting the asset list in descending order of value. In a related embodiment, presenting the asset list comprises presenting the asset list based on market demand.

At 406, an indication is received from the first consumer to transfer the asset. In an embodiment, the indication from the first consumer to transfer the asset is an indication to transfer ownership of the asset. Transferring ownership (e.g., selling) may be the default mechanism of transfer. In most cases, the transfer of ownership include a movement of location of the asset (e.g., shipping a computer to a new owner). In other cases, transferring some assets, such as real property may not involve a physical relocation of the asset. Other assets, such as a web site, may be ephemeral and may not relocate in the same manner as a tractor. In another embodiment, the indication from the first consumer to transfer the asset is an indication to transfer physical control of the asset. When lending or renting an item, for example, physical control is transferred, but ownership control is not transferred.

At 408, a set of transfer options for the asset is determined. In an embodiment, determining a set of transfer options includes identifying a current market demand of the asset and determining the set of transfer options based on the current market demand. Current market demand may be determined using sales information from the retailer platform, third-party data, governmental data, or the like. If there is no market demand, then a transfer option may not be used (e.g., if there is no market demand for a computer from 2001, then the “Sell” option may be disabled or demoted in the transfer options listing).

In an embodiment, determining a set of transfer options includes identifying a current condition of the asset and determining the set of transfer options based on the current condition. For example, if there is no market demand for a poor condition item, then the “Sell” option may be disabled or demoted in the transfer options listing.

At 410, the set of transfer options is presented to the first consumer. In an embodiment, presenting the set of transfer options to the first consumer includes presenting an option to sell, an option to donate, and an option to recycle the asset.

At 412, a selected transfer option from the set of transfer options is received. In an embodiment, receiving the selected transfer option from the set of transfer options includes receiving a verbal command from the first consumer and analyzing the verbal command. The verbal command may be a relatively simple command, such as “Sell my guitar.” Any ambiguity in the command may be resolved by the retail platform. For example, the first consumer may only have a single guitar in her history of purchases. As such, the retail platform is able to distinctly identify the guitar referred to by the command. If there are multiple guitars in the order history, then additional interactions with the first consumer may be made by the retail platform to disambiguate the reference to “guitar.” By using a relatively simple verbal command, the user experience is improved.

At 414, a transaction based on the selected transfer option is conducted. The transaction may include selling and shipping the item, arranging a trade or disposal, or other transactions described herein.

In an embodiment, conducting the transaction based on the selected transfer option includes initiating a sale with a second consumer registered with the retail platform and settling accounts of the first and second consumer based on the sale.

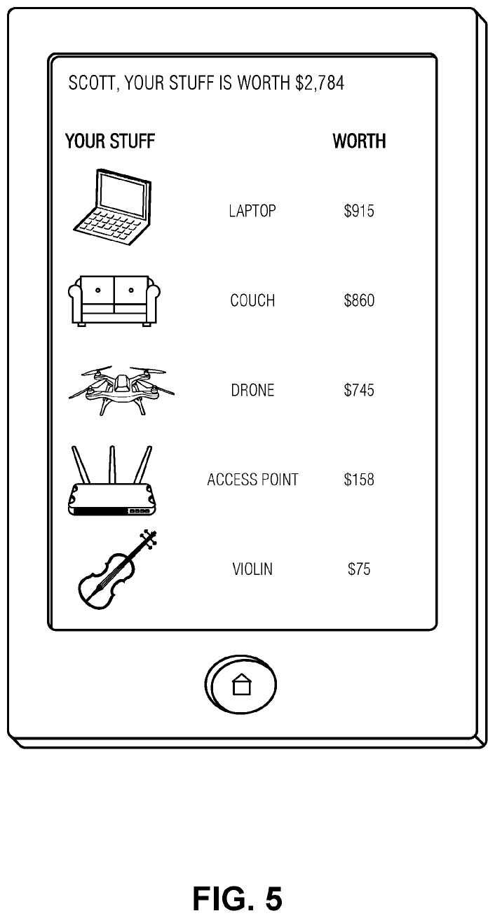

FIGS. 5, 6, and 7 are examples of user interfaces to interact with items, according to several embodiments. These interfaces are represented as a mobile device application, but other embodiments can be implemented, such as voice prompts for a virtual assistant or smart speaker.

FIG. 5 illustrates an inventory of a user's items. Here, the market price for the items is displayed along with the item. Such an interface can prompt users to dispose of items when the user's perceived worth falls below the market. This enables items to flow to those who would more likely use the item to greater effect, reducing waste by promoting reuse. The list of items may be ordered in various ways. For instance, the list may be ordered by worth from most value to least value, by market demand (e.g., based on recent sales in a month), or by other variables.

The user interface shown in FIG. 5 also includes the total estimated value of the items that are in the inventory. This provides a quick snapshot of value or worth to the user, which is useful for the user to determine how much is available if they were to liquidate all items in the inventory list. The total worth may be based on the assumption that everything is sold at a below-market value. This is to present a more realistic valuation of the inventory list based on a quick liquidation of these items.

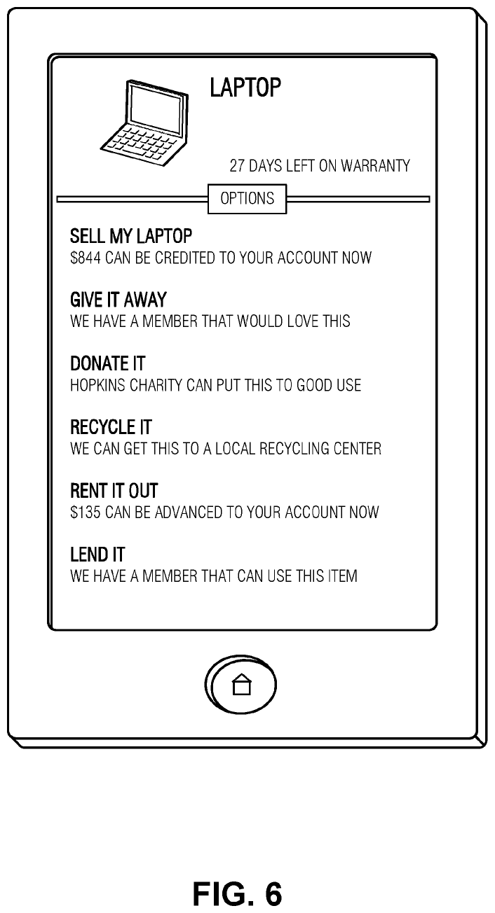

FIG. 6 illustrates a user interface after an item (e.g., a laptop) is selected (e.g., from the user interface illustrated in FIG. 5). Illustrated are various options the user can select to dispose of the item. Under the “sell” option, the user can sell via set-price or auction. In an example, the user can offer the item for rent to others. In an example, the user can have the distributed inventory system create a listing to trade the item for another.

Recycling and disposal can provide information or resources to enable the user to dispose of the item responsibly. Such information can include where to deposit items. In an example, the user can be provided a voucher or a coupon to dispose or recycle the item.

Item reuse can include gifting (e.g., donating) the item to an organization or another person. Such reuse can be tracked to provide a seamless way to recoup tax benefits, for example, if allowed by regulators. In an example, reuse involves informing the user of other uses for the item or its constituent parts. This can include instructions for disassembling the item, constructing a new item from the item, etc.

In the user interface of FIG. 6, that the amount of remaining warranty on the item is displayed for the user. The warranty information is useful for the user to further evaluate the item's worth or usefulness.

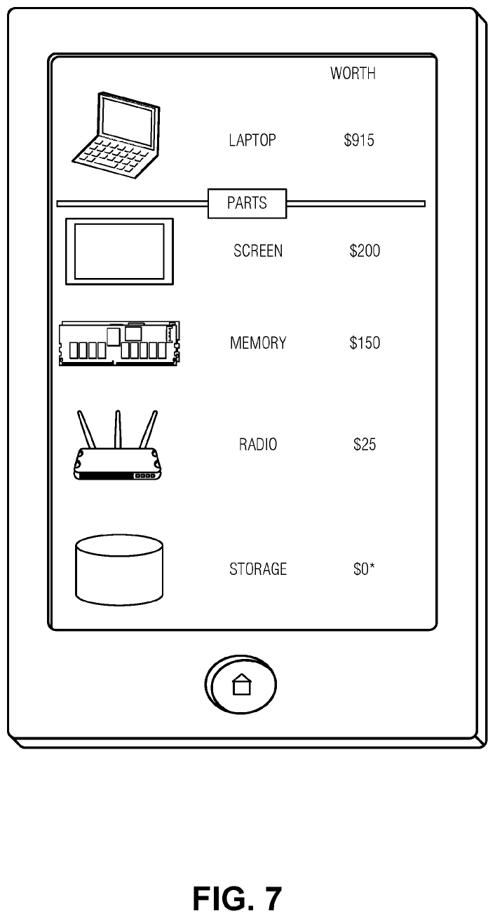

FIG. 7 illustrates a parts breakout user interface. Much like the display of FIG. 5, here a market evaluation for the individual parts can be provided.

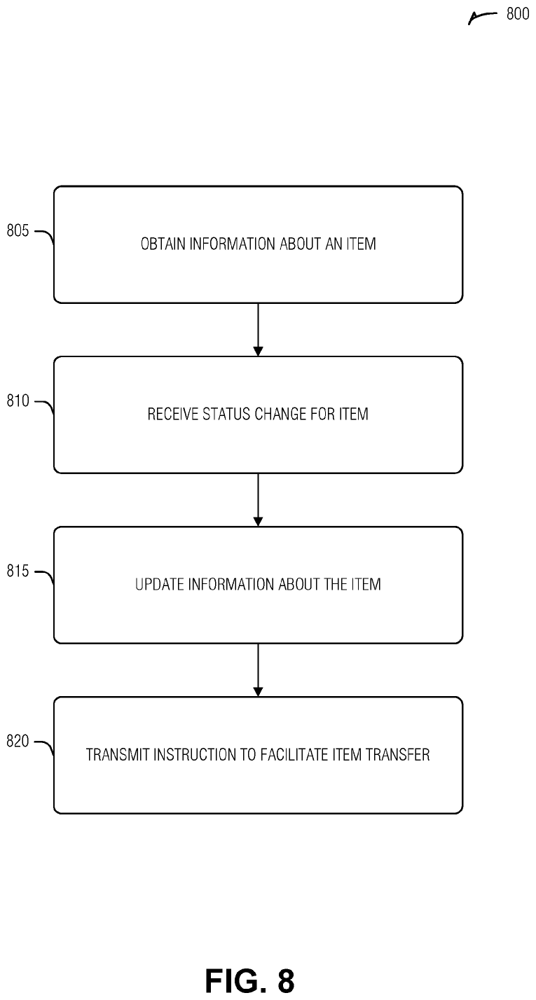

FIG. 8 is an example of a method 800 for a distributed inventory management system, according to an embodiment.

At operation 805, information about an item is obtained in response to transfer of the item from one location to a second location. Here, the information obtained from a management system corresponding to the first location. In an example, the management system corresponding to the first location is a retailer database. In an example, the second location corresponds to a purchaser of the item. In an example, the item is a part in a second item.

At operation 810, a status change event is received for the item. In an example, the status change event is an indication to sell the item. In an example, the indication to sell the item is based on a voice command received at an intelligent microphone system.

In an example, the method 800 includes the operations of requesting a condition assessment in response to receiving the status change event, and receiving a characteristic of the item in response to the condition assessment. In an example, the condition assessment request includes instructions to capture at least one of an image or video of the item. In an example, receiving the characteristic of the item includes receiving the image or video of the item and invoking an inference engine on the image or video to produce the characteristic.

In an example, the status change event includes an ambiguity. Here, as part of operation 810, the method 800 may include operations to select an inquiry from a set of inquiries to resolve the ambiguity and transmit the inquiry to an author of the status change event. Then, the status change event can be updated with an answer from the author to resolve the ambiguity. In an example, the set of inquiries are voice prompts. In an example, the following operations may be used to select the set of inquiries. A profile for a user of the item is retrieved. Here, the profile includes a set of items of the user. Characteristics of the user's items can be collection and a set of differentiating characteristics calculated. In an example, the calculation performed by subtracting an intersection of characteristics across the items from each of the items. The set of inquiries can then be filtered to remove inquiries that are not directed to the differentiating characteristics.

In an example, the status change event is notification that the item is an accessory item for a second item of a user. In an example, the status change event is notification that the item has changed in value in a market.

At operation 815, the information about the item is updated based on the status change event. In an example, updating the information about the item based on the status change event includes recording (e.g., changing or adding) the characteristic of the item as reported by the user.

At operation 820, an instruction is transmitted to enable moving the item from the second location to a third location based on the updated information about the item. In an example, the instruction creates a listing for the item in an electronic marketplace. In an example, to create the listing, the item is correlated with a class of items. A market price can be calculated for the item based on the class of items. This market price is included in the listing when the listing is created.

In an example, where the status change event is a notification that the item is an accessory item for a second item of the user, transmitting the instruction transmitting an offer to transfer the item to the user. In an example, where the status change event is notification that the item has changed in value in a market, transmitting the instruction includes transmitting an offer to create a transaction for the user.

The text below, until the text describing FIG. 11, illustrate some additional details or examples that can be combined with the material described above, or used on their own. For example, consider the following end-of-use consumer product support system. This example relates to a software based voice enabled consumer product support system called “Afterlife” that can be used by an electronic commerce company to dramatically simplify and thoughtfully address the issues that arise when a consumer is done with a product that he/she bought from said electronic commerce company.

Currently, the customer support systems that internet retailers and electronic commerce companies offer does not operate beyond the company's return-for-refund policy window closing date. Electronic commerce companies offer no product support services for products months or years after their initial purchase. It is desirable to create a support system to address the issues that arise at the end of a product's life with respect to the consumer. Here, such a system is described to make it a substantially passive, quick and painless experience. A voice enabled system makes it easier to access and initiate this End-Of-Use product support.

Typical issues that arise when a consumer is done with a product include: How do I get rid of it? Can I sell it? Is it worth anything? How do I sell it? Where do I sell it? Does anyone want it? Do I have time to sell it? Should I try to fix it? Where would I have it repaired? Is it under warranty? Can I give it away? Who'll take it? How do I find someone who wants it? Where is the manual? Would it make someone else happy to have it? Can I donate it? Should I just throw it in the trash? Can it be recycled? I don't want to spend time or effort on this! Help!!! Alexa!?

Currently, if you'd like to sell a used product, you can actively do so on marketplaces like Ebay or on Craigslist or Facebook. But people who buy most of their things new may wish to avoid putting time and effort into actively selling a used product and all that that entails. Some people just don't have the time to work on selling their used product(s). Getting top dollar for their used product(s) is not a priority for them. This presents an opportunity to create a marketplace for quick effortless sales.

Large electronic commerce companies like Amazon already know every detail about everything you own because you bought all of your things from them. The electronic commerce company knows when you bought the item, whether or not it is still under warranty and where your product lives. It knows where it came from, when it was made, how many owners it had, the type of owner you are, how popular the product is and common points of failure based on consumer product reviews, all with unmatched traceability that is nothing short of eerie. The only thing the consumer may need to tell them is the condition the product is in. For certain products and functions, the product's condition is irrelevant and unnecessary. For certain owners with a good history of selling their well-maintained used products, it may go without saying (it may be assumed) that the product is in good or better than good condition, thereby making it possible to skip a step.

Typing in or clicking a multiple-choice button to enter a used product condition description is not as telling as a verbally communicated condition description spoken directly into a microphone by the owner.

The aforementioned deficiencies are addressed, and an advance is made in the art, by a voice enabled end-of-use consumer product support system called “Afterlife” that can be used by an electronic commerce company to dramatically simplify and thoughtfully address the issues that arise when a consumer is done with a product that he/she bought from said electronic commerce company.

When the consumer is finished with a product that he/she purchased from an electronic commerce company, the system can sell it for them, give it away for them, buy it back from them, trade it, rent it, lend it, pawn it, donate it, recycle it or help the customer dispose of it responsibly, earning the customer store credit, cash or rewards in the process to put toward future purchase(s) from said electronic commerce company.

The system and these services can be made available exclusively for products purchased from said electronic commerce company to create a compelling incentive to patronize said electronic commerce company with extreme loyalty. The system and its services add value to and extend the lifecycle of the products that the electronic commerce company sells, bringing joy to more people while reducing waste and protecting our environment. This can improve the electronic commerce company's eco-friendly image with closed loop mindfulness similar to how beer companies run ads to encourage sober driving.

Here, the electronic commerce company shall be referred to as “Amazon” throughout this specification. The electronic commerce company's voice enabled system shall be referred to as “Alexa” throughout this specification.

With Afterlife, Alexa thoughtfully handles all issues that arise when you're done with a product you bought on Amazon. When you're finished with a product you purchased on Amazon, Alexa can sell it, give it away, buy it back, trade it, donate it, recycle it or help you dispose of it responsibly, earning you Amazon credit in the process to put toward your next Amazon purchase(s). Amazon Afterlife by Alexa is another compelling reason to buy everything on Amazon as this service is only available for products you buy on Amazon.

Instant sales—Alexa can make a sale instantly by connecting a seller with a buyer for popular (used) products in the Afterlife marketplace, like how market sell orders trade on the stock market. The items sell for the best available price at the time. Amazon Afterlife sets the minimum sell price at 40% of the current market price (this can be adjusted). This works because getting an instant sale for a used product that the consumer may have considered throwing in the trash, beats working to get top dollar for your used product. The Afterlife marketplace is built for high-speed passive selling of used products. Instant gratification beats leg work and waiting and having another thing on your mind. Buyers line up and love it because they get great deals. The buyer sets a minimum condition level and a price they are willing to pay equal to the minimum price or more to insure they are first in line. This method allows people to sell a used product instantly.

The Afterlife online marketplace enables users to passively sell used products instantly for the best available price at the time for when effortless speed is a priority over getting top dollar. Buyers line up to place buy orders because they stand to get a great deal, so the likelihood that there is a willing buyer for the item at any given time is high. A minimum buy order price is set to avoid an unacceptably low sale price.

Here, a patron is enabled to passively sell their used product by simply asking the electronic commerce company's voice enabled device to do so. The following example demonstrates how this would work with Amazon as the electronic commerce company and Alexa as it's is voice enabled system with Afterlife Options.

Alexa can sell it.

### EXAMPLE #1

Customer says, “Alexa, sell my TV.”

Voice enabled system responds, “Okay, it's sold. I'll emailed you the details.”

### EXAMPLE #2

Customer says, “Alexa, sell my Electric Skateboard.”

Voice enabled system responds, “Okay, what condition is it in?

Customer says, “Like new. I barely used it.”

Voice enabled system responds, “Okay, it's sold. I'll email you the details.”

### EXAMPLE #3

Customer says, “Alexa, sell my couch.”

Voice enabled system responds, “Okay, I can sell it. But, I have a Prime member family down your street that would love to have it. Would you like to give it to them?

Customer says, “Okay. Give away my couch.”

Voice enabled system responds, “Great! This will make them very happy. I'll email you the details.” (The receiving Prime member is encourage to post a photo of them putting the couch to good use).

### EXAMPLE #4

Customer says, “Alexa, sell my Guitar.”

Voice enabled system response, “Okay. Your electric guitar?” (b/c it's their most recent purchase)

Customer says, “No, my acoustic one.”

Voice enabled system response, “Okay. What condition is it in?”

Customer says, “Pretty good. Everything works. It has a couple of scratches but nothing major.”

Voice enabled system response, “Okay. It's sold. I'll credit your account and email you the details” (Prime members with a solid history will receive the Amazon credit instantly if the amount is less than their allowed limit for advanced credits. Lie detection software can be employed to help Alexa determine if the customer is telling the truth or if he/she might be unsure about the condition he/she is claiming. This additional information is used to help determine if advancing the credit is higher risk.)

### EXAMPLE #5

Customer says, “Alexa, I'm moving. Sell all of my stuff and give away what you can't sell.”

Voice enabled system response, “Okay, I'll email you the details and I will help you recycle and dispose of the things that are unwanted.”

### EXAMPLE #6

Customer says, “Alexa, Fred passed away. Please sell all of his stuff and give away what you can't sell.”

Voice enabled system response, “Okay, I'll email you the details and I will help you recycle and dispose of the things that are unwanted.” (the email will require confirmations)

Using the elements of this example, the consumer can passively have Alexa sell it for him/her. The consumer doesn't need to know the model number or worry about reviews or accounts or postings or negotiating or bids or emails from strangers or wait for it to sell or for the auction to end or learn marketplace platform rules, take photos or additional logins or payment methods or set-up time delays, pricing or descriptions or even be conscious of the sale(s), etc . . . .

Proceeds from the sale(s) are quickly credited directly to your Amazon account. Amazon can profit from every transaction. Alexa may deem the product unsellable based on the product and the condition of the product. If unsellable, she will suggest other Afterlife Options based on product info, condition, manufacturer's promotions (buy the new model with a discount if you drop the old one in the mail type promotions), warranty's, and user feedback. She can also help you decide which Afterlife option is best for your situation.

Typical consumer responses used to describe the condition of the used product include: Not so good, Good, pretty good, Very Good, Great, Excellent, Perfect, Like New, Never Used, barely used, Never opened. Afterlife employs lie detection software. So, by answering the “what condition is it in?” question verbally, the system can determine if the consumer might be lying about the condition of the product based on voice patterns (a camera can be added to monitor body language). If the system thinks the consumer may be lying or unsure about what they are claiming, the system may not credit their Amazon account instantly. Stating verbally what condition your product is in tells the system more information than just typing the answer in or clicking a multiple-choice button. This allows the system to make better, more informed decisions about the condition of the used product and the transaction overall. Verbally communicating the command also serves to partially verify the consumer's identity. If a women's voice tries to sell something that a man owns, it may not allow or support the transaction unless enabled to do so. Or a secondary method of confirmation may be required.

It is possible to make the sale instantaneous if one or more buyers are already registered (like a wedding registry) to buy your used product or is on a waitlist for such a product. Because the goal is not to get top dollar for the product, it sells at or below market value. The trick here, is not to care about getting top dollar for it. Remember, you need to put in time and effort to get that extra money. For many Amazon Prime members, it's not worth their time or the effort to get top dollar. So, the buyer stands to get a great deal and the seller gets a quick effortless sale for something they may have considered throwing in the trash. A financial stock exchange market order type marketplace is possible where buyers can place “buy orders” for a desired product or type of product for which they set the condition level (or level range) and the price they are willing to pay for it. So, when a seller wants to sell, the order is matched to the best available current price (like a financial Market Order) and the sale is made instantly. Amazon will set minimums to avoid selling it for less than 40% of its market value (this % can be adjusted). Amazon will determine the market value based on the product details, age, popularity and the seller described condition it's in and comps. Alexa may ask you questions to help her determine what condition it's in. Amazon may decide to buy it back instantly themselves to relist it for sale at a higher price. Alexa may ask additional questions to better understand what condition your used product is in an effort to get you the most value possible. Because the electronic commerce company already knows everything about your product and history, buyers can have access to more product info than what is available on any other marketplace with zero effort on the part of the consumer.

Alexa can give it away.

With Afterlife, Alexa can arrange to give a used product away to a local Amazon Prime member (or Amazon Prime family member if enabled local or otherwise). It's a “who wants it” type Amazon listing or posting to local members and the world if enabled. It is possible to confirm this “give away” instantly if people are registered (like a wedding registry) or waitlisted as wanting for such a product. People can set the minimum condition level that they are willing to accept. Once the giveaway is fulfilled, Alexa will post your good deed to your Amazon profile and the recipient can post comments and photos of them putting your old product to good use. You can leave it outside your home for pick up. You don't need to be present for the pickup. You don't need to meet anyone. Alexa can schedule the pickup for a certain time and place. You can also schedule the pickup to be at a local Amazon Drop location.

### EXAMPLE #7

Customer says, “Alexa, Get rid of my kitchen table for me.”

Voice enabled system responds, “Okay. What condition is it in?”

Customer says, “It's in good condition”

Voice enabled system responds, “I have a Prime member family located a few blocks away that would love to have it. Should I give it to them?”

Customer says, “Yeah, let's do that. Set it up.”

Voice enabled system responds, “Great! This will make them very happy. I'll email you the details.” (the email will explain that they don't have to be present for the pickup and that they can just leave the table outside their home for pick up tomorrow morning. The email will ask if tomorrow morning is okay or if another time would be better.)

Alexa can trade it.

With Afterlife, Alexa can trade your used product for something you want that another Amazon Prime member bought on Amazon and is no longer using. It is possible to make this trade instant if the holder of the used item you want is waitlisted for a used product like yours or if they accept your proposed trade offer.

Alexa can donate it.

With Afterlife, Alexa can see if any local charitable organizations want your used item. She can make the necessary arrangements. She may be able to schedule a charitable pick up and provide you with a tax credit for the donation. Alexa will post your good deed to your Amazon profile and the recipient can post comments and photos of them putting your old product to good use if enabled. It is possible to make this donation instantly if the organization has registered or is waitlisted for such a product.

Alexa can recycle it.

With Afterlife, Alexa may be able to have the product removed for recycling or suggest recycling methods based on expert eco-warrior concepts and best practices. This depends on the product, your location and a number of other variables.

Alexa can repurpose it.

From time to time, depending on the product, a request may be made to collect certain products to be repurposed. For example: The company Terracycle might put in a request to Amazon to receive all used Toothbrushes for repurposing as bracelets. Or artistic projects may be looking to collect a certain used product for repurposing, in which case, Alexa can arrange for that with Afterlife.

Alexa can help dispose of it.

With Afterlife, Alexa can suggest best methods to dispose of the item based on product info and expert eco-warrior concepts and best practices. You don't need to know the local trash ordinances. (Example—How to best dispose of the KEYKO Genuine KT-670 6V 7Ah SLA Sealed Lead Acid Battery?) Alexa can also schedule a trash pickup. This service is especially helpful when moving or between your normally scheduled trash pickups.

Alexa can help revive it.

With Afterlife, Alexa may be able to bring your old product back to life if it broke or is missing parts. Alexa knows everything about your product because Amazon sold it to you and she has access to all relevant manufacturer troubleshooting data and parts lists with many of these parts available for purchase directly on Amazon. She can also suggest common fixes found in consumer reviews and comments online. She can also call the product's manufacturer's customer support line with you on the line and tell them the model number and answer any other product questions they may have for you or she can submit an Incident Ticket on your behalf to have them contact you directly. She can rate the manufacturer on Amazon based on how well they help you. She can also check to see if you're product is still under warranty and may be able to arrange to have it repaired or replaced. She'll keep track of all the details. She will just handle it for you. You don't even need to know the model number. Lost the manual? Alexa can email it to you. Missing a part? Alexa can locate the part and sell it to you.

### EXAMPLE #8

Me: “Alexa, I lost the charge for my electric skateboard”

Alexa: “Not a problem, I can order a new one for you. The cost is $35.99. Is that okay?

Me: “Yes, please order that for me.”

In some cases, depending on the product and it's manufacturer, if the product did not last as long as expected or failed, Alexa may be able to get the manufacturer to buy it back from you or replace it even if the product is not under warranty. Some manufacturers are willing to buy it back so that they can study the damaged item in an effort learn what what wrong so that they can make improvements. The buy back price may be lower than the initial sale price. But, that is better than nothing in most cases.

### EXAMPLE #9

Me: “Alexa, My TV won't turn off.”

Alexa: “I will call Sony Customer service with you. Not to worry, I will tell them the model number and issue and help you figure this out. I know everything about your product including common issues and troubleshooting procedures. (she says this as she calls the Sony Customer service support line.) Hello, It's Alexa from Amazon. We sold a Bravia Sony TV Model #3290350234 to our friend Scott here. He is having trouble turning the tv off. Can you recommend a solution? . . . ”

Alexa can return it.

(This option is only available if within Amazon's return period)

### EXAMPLE #10

Customer: “Hey Alexa, Return the hose I just bought.”

Alexa: “Okay, why would you like to return it?”

Customer: “I don't need it.”

Alexa: “Okay, would you like me to send a printed return shipping label in the mail for a $1 fee? Or I can email you the return label for you to print, if you'd like.”

Customer: “Okay, yes, please send me the printed label in the mail.”

Alexa can lend it.

With Afterlife, if you are no longer using your product, but you may need it later and a local Prime Member is looking to borrow such a product, Alexa can lend the product out to the prime member, if you'd like to help. This is particularly useful in a state of emergency and/or a natural disaster or just an opportunity to practice the golden rule.

Alexa can rent it.

With Afterlife, if you are no longer using your product, but you may need it later and a local Prime Member is looking to rent such a product, Alexa can rent your product out to the prime member, if you'd like. Proceeds from the rental are credited directly to your Amazon account or they can be donated to the charity of your choice.

Alexa can pawn it.

If you'd like to buy something on Amazon but, you don't have enough money or Amazon credit to do so AND you have a product that you bought from Amazon, Amazon can lend you 30% of the used product's market value to put toward the purchase of the new Amazon product you want. You would send your used product to Amazon to hold for you for 1 month. If you pay back the loan within the one month timeframe, Amazon will send you back your used product. If the month passes and the loan is not paid, Amazon will keep the used product and resell it.

Old products lying around could help pay for your next Amazon purchase(s). Products that take up space that you don't use or need can go to someone who will use them. Products that you would otherwise throw in the trash, could be sold to someone who wants it. Products that you would otherwise throw in the trash, could be given to someone who will use them. Products that you would otherwise throw in the trash, could potentially be recycled or repurposed. Products that you would otherwise throw in the trash, might be put to better use or a better way to dispose of it may be available. Amazon stands to profit or benefit socially from every Afterlife transaction.

The system simplifies the experience by defining the products you bought from Amazon as My (Noun). For example, the system knows that for your account . . .

My TV=Sony Bravia Model No. 3049723594385 Manufactured Fall 2015 bought on Mar. 21, 2014

My Toaster=Badk'd Model No.: 3290873498 Style.0938432 bought on Apr. 21, 2012

My Table=Coavas Kitchen Dining Table White Round Coffee Table Modern Leisure Wooden Tea Table Office Conference Pedestal Desk Bought on Apr. 21, 2017

My Chairs=Winsome Wood Windsor Chair in Natural and White Finish, Set of 2 bought on Jan. 12, 2018

My Electric Skateboard=ACTON BLINK Lite V2|Summer Sale|World's Lightest Electric Skateboard for Youth|With LED Lights|Up To 5 Mile Range|10 MPH Top Speed|Bluetooth Remote Control Included bought on Jul. 12, 2018

My Guitar (1)=Martin Road Series DRS1 Dreadnought Acoustic-Electric Guitar Natural bought on Jul. 18, 2007

My Guitar (2)=Fender Standard Stratocaster Electric Guitar—Maple Fingerboard, Arctic White bought Sep. 28, 2017

Etc . . .

Here, a consumer can easily reference the products bought from the electronic commerce company.

Here, users are enabled to passively sell their used products instantly for the best available price at the time for when effortless speed is a priority over getting top dollar. Buyers line up to place buy orders because they stand to get a great deal, making it highly likelihood that there is a willing buyer at any given time. A minimum buy order price is set to avoid an unacceptably low sale price. This minimum buy order price can be adjusted if desired.

These examples provide an End-of-Use consumer product system that can be useful when someone passes away for handling their affairs and figuring out what to do with their things.

These examples provide an End-of-Use consumer product system that can be useful when someone moves and needs help figuring out what to do with their things.

These examples provide a way for people to buy or receive products that may have otherwise been thrown in the trash.

These examples provide a way for the consumer to salvage money from their old stuff with zero effort and no time investment.

These examples provide a way for people to get crazy deals on used products. Low pricing that is not generally available on any other online marketplace as getting top dollar is not a priority for these sellers. On eBay a low price may be a red flag (too good to be true). That is not the case with Amazon Afterlife.

It is within the scope of these examples to instantiate an End-of-Use support system as described without it being voice enabled.

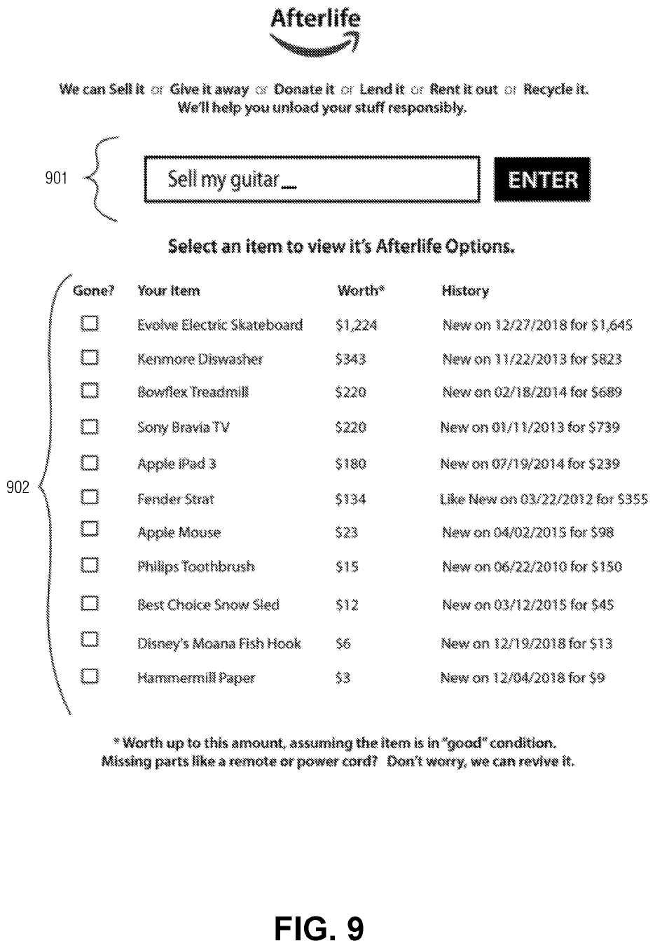

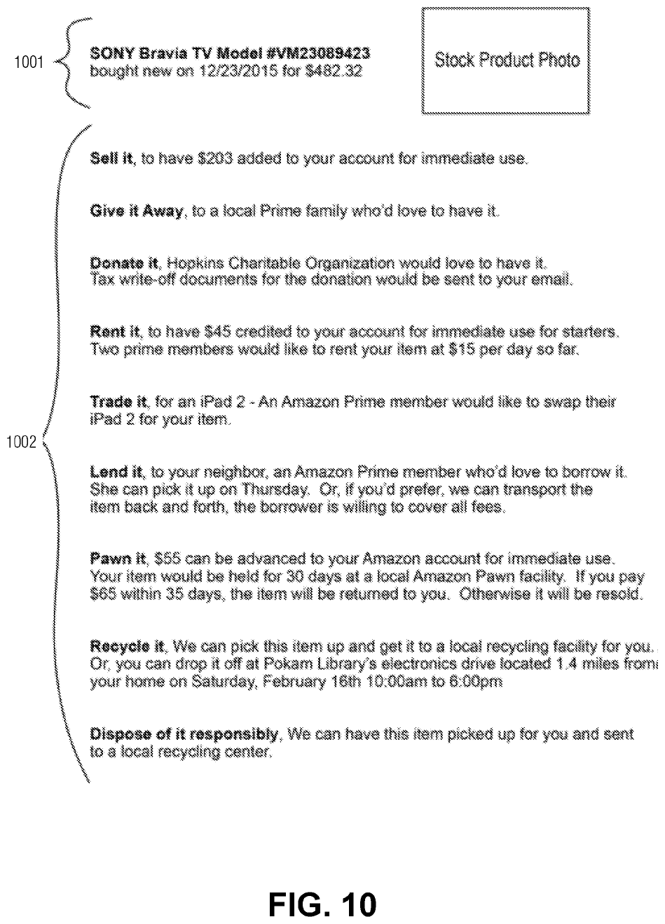

In an example, consider a second end-of-use product support system, described below, which references FIGS. 9 and 10. Again, these example relates to a computer method and system for consolidating, managing, initiating and executing end-of-use product support services over the internet to be employed by an electronic commerce company for dramatically simplifying and thoughtfully addressing issues that arise when a consumer decides he/she no longer has use for an item that he/she bought from said electronic commerce company.

When a consumer is finished with a product that he/she purchased from an online retailer or electronic commerce company, the system can sell it, give it away, buy it back, trade it, rent it, lend it, pawn it, donate it, recycle it or help the customer dispose of it responsibly, potentially earning the customer store credit, cash or rewards in the process that can be immediately put toward future purchase(s) from said electronic commerce company.

The system and these services can be made available exclusively for products purchased from said electronic commerce company to create a compelling incentive to patronize said electronic commerce company with extreme loyalty. The system and its services add value to and extend the lifecycle of the products the electronic commerce company sells, bringing joy to more people while reducing waste and protecting our environment. This can improve the electronic commerce company's eco-friendly image with closed loop mindfulness.

Current customer support offered by online retailers and electronic commerce companies like Amazon are extremely limited after the return-for-refund period ends. The return period typically lasts 30 to 60 days from the date of purchase. Do they care what happens to the products they sell after the return period ends?

Some retailers and electronic commerce companies try to upsell expensive product protection plans with clever expiration dates. These plans do not support a product beyond premature failures from normal use that occur within a year or two from the date of purchase. Some products come with a manufacturer's guarantee or warranty. These are also limited to product failure and trial periods. No support is offered to help the user salvage or pass the item on or recycle the item. The customer is “on their own” to figure it out.

It is desirable to create a support system to address the issues that arise at the end of a product's life with respect to the consumer. This may occur months or many years after the date of purchase. This system would support products at the end of their use with respect to the consumer. Such services shall be referred to throughout this specification as End-Of-Use product support services. A voice enabled system like Alexa can make it even easier to access and initiate these End-Of-Use product support services and activities.

Customers may decide to get rid of an item for any of the following reasons. These reasons are presented here in order from most to least common.

1. The customer just doesn't need or want the item anymore.

2. The customer would like to purchase an updated version of the same item or a similar item made by a different manufacturer.

3. The item is missing parts (remotes, power cords, etc . . . )

4. Item has stopped functioning properly.

5. The item is damaged or broken.

Typical thoughts and issues that arise when a consumer is done with a product include: How do I get rid of it? Can I sell it? Is it worth anything? How do I sell it? Where do I sell it? Does anyone want it? How long is this going to take to sell? Should I try to fix it? Is it worth fixing? Where would I have it repaired? Is it under warranty? Can I give it away? Who'll take it? How do I find someone who wants it? Where is the manual? I don't have the remote. I can't find the power cord. Would it make someone else happy to have it? What if they think it's stolen? What if the buyer is a scam? Can I donate it? I hate packing and shipping things. Should I just throw it in the trash? Can it be recycled? How do you recycle this? I don't want to spend time or effort on this! Help!!! Alexa!?

Currently, if you'd like to sell a used product, you can actively do so on marketplaces like eBay over time. But some people would like to avoid putting time and effort into actively selling a used product and all that that entails. Some people just don't have time to work on selling their used item(s). Or, their time is more valuable if spent elsewhere. Getting top dollar for their used item(s) is not a priority for them. This presents an opportunity to create a marketplace for quick effortless sales.

The company that 1st sold the product to the customer is in a unique position to provide frictionless End-Of-Use product support far better than any third party.

Large electronic commerce companies like Amazon already know every detail about the products its customers own because they purchased these items from them. The electronic commerce company knows when the customer purchased the item, whether or not it is still under warranty and where the item lives. It knows where it came from, when it was made, how many owners it had, the type of owner the customer is, how popular the product is new and common points of failure based on consumer product reviews, all with unmatched traceability that is nothing short of eerie. None of this information needs to be entered by the customer. The only thing the consumer may need to input is the condition the product is in. For certain products and functions, the product's condition is irrelevant and unnecessary. For certain owners with a good history of selling their well-maintained used items, it may go without saying (it may be assumed) that the item is in good or better than good condition, thereby making it possible to skip the step of determining the item's condition.

An electronic commerce company can employ software to put all End-Of-Use services in one place so that their customer can easily view all their options and decide which option is best for them, other people and the environment. Software can help solve the problem of irresponsible waste. Software can make it much easier to facilitate item specific waste management in mainstream commerce. Focusing on the 1st owners at End-Of-Use creates more transactional opportunities and greater social benefit than a 2nd hand approach.

An End-Of-Use product support system and method for finding and offering one or more better alternatives to throwing the item in the trash is needed. Helping customers figure out the best thing to do with their item when they are done with it is necessary. The best things to do are usually the hardest. Figuring out how to sell, give away, donate or recycle an item are not simple tasks for most people. But, by turning these difficult tasks into frictionless clicks with software, and by delivering an option better than simply throwing it in the trash or putting it curbside for trash pick-up, and by putting the customer first, we can make a real difference in how products are shared, handed down, reused, repurposed, recycled and even how they are designed going forward.

Currently, it is difficult to quickly access, view and identify the most valuable and/or in-demand items a customer owns. A user's order history is not structured like that. Therefore, display of previously bought items can be organized and ranked by value—from the most valuable in-demand items down to the least valuable undesirable items. It must be made easy for customers to select items they bought on from the electronic commerce company (Amazon) and to view and select Afterlife Options for each item. End-Of-Use product support services should be managed online. The support should be available indefinitely.

A customer can access Afterlife on the Amazon Website or through a mobile app or by using an Alexa Skill. The customer can then select a previously purchased item and initiate Afterlife Options for said item.

The Amazon Afterlife Webpage(s)

A customer can log into their Amazon account and select Afterlife to open the Amazon Afterlife webpage. On this page, they can search or select from a list of products they bought on Amazon in the past. The products are listed in order from most valuable and in-demand down to the least valuable and least desirable item. They can then view the Afterlife Options available for each item by selecting an item. They can then select the best available Afterlife Option for that item. The system will recommend the “best” available Afterlife Option for the item in question in an effort to maximize and effectuate the most personal and social benefit. This makes the process even simpler as the user doesn't even have to review the options. They can simply agree by selecting the “best option and it shall be done. However, the customer ultimately decides which Afterlife Option to go with.

A command bar is displayed above the list to accept specific commands from the user regarding their Amazon bought items. All Afterlife Alexa commands can be entered into the command bar and will be recognized by the system. The consumer could type a command such as, “Sell my Guitar” or “Get rid of My Guitar”. The system will then check to see if any guitars were bought in the customer's archived order history as stored in Amazon's customer database. If more than one guitar was bought, the system would display all of the guitars previously bought on Amazon by the customer. The customer would then select the guitar they are thinking of to display the Afterlife Options for that item. Every product is different and therefore different products will have a different set of available Afterlife Options at any given time.

The screen automatically displays every item the customer ever purchased on Amazon in order from most valuable and in-demand down to the least desirable and potentially worthless items. The system determines this based on the product, user history, trending prices for the item in question (or similar used items) on marketplaces online like e-bay and relevant bids placed by buyers for the specific item and items like it within the Amazon Afterlife Market and by how quickly the item sells new or had sold used in the past on Amazon.

Afterlife can also be used as a reason to buy higher quality new products in the first place, as they retain their value better. For example, Apple products hold their value better than an off-brand electronics company. It would be simple for an electronic commerce company like Amazon to add an estimated residual value vs time graphic or data to new product listings. It would be entered with new product information and stored in the electronic commerce company's (Amazon's) inventory database. Because of this, the customer may decide that buying a higher cost item is a better choice, so he/she can get more out of the item when he/she is done with it with Amazon Afterlife. This would make items that retain their value better be perceived as smarter purchases, getting the customer to spend more money and indicating to manufacturers that they should make products that last longer and that maintain value longer. This would lead to less products being produced, less waste, more money per order and longer product lifecycles.

If the customer says or enters the “Sell my (noun)” command, and this option is available for the item, then that is what the system does. There is no need to discuss or display any other Afterlife Options. If the “Sell it” option is not available for the item, the system suggests the next best option and so on down the list of options. If the customer says or enters a command for a less desirable option lower on the list, such as “Recycle my (noun)” and the system can offer one or more better options, the system will offer the better option(s) instead of just executing the requested “Recycle it” Option.

Afterlife Options

The customer can log into Amazon and select Afterlife to open their Amazon Afterlife webpage. On this webpage, a list of items they purchased on Amazon is presented in an easy to view format. The list is optimized for Afterlife purposes. The items are displayed and ranked in order from the most valuable and in-demand items that the customer owns down to the least desirable items that the customer owns. Newly bought items could appear on this list even before their respective return periods have ended if the electronic commerce company decides that's a good idea. Once an item is selected, a series of Afterlife Options are provided for the selected item. The available set of Afterlife Options for each item are determined by the Afterlife system based on the product and other factors. Some of the options may not be available at the time. The set of available Afterlife Options can change with time.

In an effort to encourage Amazon customers to upgrade to become Amazon Prime members, certain Afterlife Options such as trade it, swap it, lend it, and rent it could be reserved and made only available to Amazon Prime members. Also, prime members are seen as being more credible and more invested in the Amazon ecosystem and doing so could also boost user confidence in these Amazon Afterlife services.

Thus a way for customers to turn their item(s) into an ongoing source of income is created. The “Rent it” out Afterlife Option is a great example of this.

Afterlife and the Afterlife Options and services can also be accessed and initiated using Alexa. I am developing an Alexa Skill called Afterlife Options to do just that. It helps people figure out what to do with their old items. It helps people who bought products on Amazon, sell, giveaway, donate, revive and repair their items and/or get rid of the items easily, efficiently and responsibly.

Afterlife offers the customer one or more better alternatives to throwing the item in the trash to prevent these items from entering our landfills. Much of the system's ability to offer better options lies in its ability to make difficult tasks as easy as throwing the item in the trash. For example, currently, how to recycle an item is not a simple question. So, most people skip it and just throw it in the trash.

Amazon Afterlife makes it easy for customers to select items they bought on Amazon and to view and consider Afterlife Options for each item. End-Of-Use product support services should be managed online.

The above can be started when a customer logs onto their Amazon account and clicks on Afterlife or Afterlife Options to open the Afterlife Webpage which shows a list of items they previously purchased on Amazon (their “Amazon inventory of used items”).

1. Generate the list.

Create the List of items purchased by the customer and optimize said list for display on the user's Afterlife webpage. Here's how . . .

Make the item list.

Access the customer's complete order history stored in Amazon's customer, inventory and/or order database(s). Pull product, names, descriptions, stock photos, details, reviews and comments from the product information stored in the Amazon customer and inventory databases.

Temporarily ignoring items that the customer originally purchased new for less than $10 (from Amazon) this preset amount can be adjusted, determine the value of each remaining item on the list by accessing online marketplaces like eBay, sell.com, poshmark.com, letgo.com, gone.com, craigslist along with Amazon's own used sales to get trending used prices for the item or “items like it” if necessary. If no “comps” or comparable item sales are available, take the original price when bought new and reduce it by 40% (or another preset amount—the preset amount maybe product specific and retrieved from the product information stored in Amazon's product inventory database). Check to see if anyone placed a standing bid on the item or “items like it” on the Amazon Afterlife Market. Once a trending price for an item is determined, store this trending used price within the item's product information for a period, like 36 hours, so that this information doesn't need to be determined for this same item for other customer accounts within this period. This is meant to save computing. So, if another customer selects the same item on their Afterlife webpage, the system already knows the trending used price for the item, thereby saving the system a step.

List the items, ranking them in order from most valuable and in highest demand down to least desirable and least valuable. Include the items the customer originally bought for under $10 at the bottom of the list in order from highest original cost down to lowest cost. For items with the same cost and demand, list newest to oldest with respect to their original purchase date.

Items that were originally purchased for a higher price are not listed above items with a higher trending used price.

For example.

A $2,200 Excelsior Plano that is currently trending used at $545, would be ranked lower than an Apple iPad that was original purchased new for $900 but is trending used at $600. $600 is more than $545. So, the iPad is listed higher on the list than the plano.

2. Display the list on the customer's Afterlife webpage.

The customer can then view the list of items and select an item to view the Afterlife Options for the item in question.

With reference to FIG. 9, 901 is a command bar that helps the customer execute an end-of-use option for an item and/or search for a specific item. 902 is the optimized list of items. Item name and product information and stock product photos can be displayed along with the item's worth and the customer's purchase history with respect to the item. It shows when the customer bough the item, for how much and what condition it was in at time of purchase. The customer can select items (under the Gone heading) that they no longer possess to have those items removed from the list (and sent to the ghost list) to keep their list organized and up to date like a neat little inventory of personal belongings. The worth amount list for each item is what the item may be worth up to, assuming the item is in “good” condition. Maybe a line like “Missing parts like a remote or power cord? Don't worry, we can revive it.” would help the customer understand that these types of issues may not remove their end-of-use option to sell the item. A line like “We can Sell it or Give it away or Donate it or Lend it or Rent it out or Recycle it. We'll help you unload your stuff responsibly.” may help the customer understand what's possible with Amazon Afterlife. The customer may be instructed to, “Select an item to view it's Afterlife Options.” or “Select an item to view your Afterlife Options.”

3. Display a search bar above the list.

The search bar can help the customer find specific items quickly. If the user enters or says a phrase containing the phrase “my (noun)”, bring the relevant items that could be described by the “(noun)” to the front for immediate selection.

For example . . .

Customer types in “Get rid of my TV for me”. The system would then bring up any TV's the customer has ever purchased on Amazon for the customer to select from because the noun in this case is “TV or Television”. If the user no longer possesses a TV that they bought on Amazon because it was placed on their “Ghost list” (the term Ghost List will be explained later in this specification), the TV would come up ghosted and would explain why it is on the “Ghost” list, including all relevant dates. Reasons include:

A) The customer already got rid of this item using Afterlife and no longer possesses the item.

B) The customer moved the item to the ghost list when attempting to clean up their Afterlife list because they no longer possess the item.

If the customer has only ever bought one TV on Amazon, only that TV would be brought to the front. In this case the customer's Afterlife Options for that TV open or the condition question(s) is presented first. Also, if the customer bought more than one TV, but the other TV(s) is on the “Ghost” list and only one TV remains on the item list, the selection step can be skipped and the remaining TV is assumed to be the item in question.

4. Check to see if the item selected by the user requires any condition questions to determine the condition of the item. This information is stored in the inventory database along with the product information. Going forward, when new products are added to the inventory database, additional product information shall be requested and entered, including any condition questions for use in the products' Afterlife to determine the condition of that particular item.

5. If one or more condition questions are to be asked, display the condition question(s) and await response from the user. These questions may be displayed along with the item info (stock photo, name, model, brief description, original purchase price, etc . . . )

For example . . .

What condition is it in? Like new? Good? or Poor?

Is it fully functional?

Do you have the remote?

Do you have the power cord?

Condition questions help the system determine which Afterlife Options to enable for the item in question and how to structure each available Afterlife Option for the item in question. Most items will only require a single question—“What condition is it in?”. Follow up questions would be used to determine if any replacement parts will be needed to “revive” or restore the item.

6. Determine which Afterlife Options should be made available. This is explained in the Afterlife Program presented with additional details section below.

7. Display the available Afterlife Options for the item along with each outcome. This gives the customer a chance to see all of their options laid out in front of them all in one place on a single page—see FIG. 2. So, that they may weigh their options. The Afterlife Options are presented as offers.

For Example, the following list of end-of-use options would be listed all on a single webpage.

SONY TV Model #23089423 bought new on Dec. 23, 2015 for $482.32

Sell it, to have $203 credited to your account for immediate use.

Give it Away, a local Prime member family would love to have it. They can pick it up. A pickup time can be scheduled.

Donate it, Hopkins Charitable Organization would love to have it. They can pick it up on Thursday. Tax write off documents for the donation would be sent to your email.

Rent it, to have $45 credited to your account for immediate use for starters. Three prime members would like to rent your item at $15 per day. Each are willing to pay for shipping back and forth. We can help with scheduling. The first person would like to know if they can pick it up on Wednesday to returned on Friday.

Trade it, for an iPad—One Amazon customer would like to trade or swap you their iPad for your item. Otherwise, your item would be listed as available for trade or swaps. You can also try to trade or swap it for something you like with other Amazon prime customers on Afterlife Swaps:

Lend it, to your neighbor, an Amazon Prime member who'd love to borrow it.

She can pick it up on Thursday. Or, if you'd prefer, we can transport the

item back and forth. The borrower is willing to cover all fees.

Pawn it, $55 can be advanced to your Amazon account for immediate use. Your item would be held for 30 days at a local Amazon Pawn facility. If you pay $68 within 35 days, the item will be returned to you. Otherwise it will be resold.

Recycle it, we can pick this item up and get it to a local recycling facility for you.

Or, you can drop it off at Pokam Library's electronics drive located 1.4 miles from your home on Saturday, February 16th 10:00 am to 6:00 pm

Dispose of it responsibly, we can have this item picked up for you and sent to a local recycling facility.

The customer then selects an Afterlife Option to execute. Ask an additional question(s) or questions based on the selected Afterlife Option to further customize the experience if necessary. This additional information can be used as a default when the same option is selected for any other items by the customer if relevant going forward such as not wanting takers to pick item up at their home or during certain hours, etc . . . .

Thus, the best available options for the customer at End-Of-Use can be worked out and all of these options can be presented in one place and on one page without the customer having to input any information other than the item's condition if necessary. The options are presented as offers so the customer can quickly glance and understand what each option is offering.

With reference to FIG. 10, 1001 is the selected item's product information and 1002 is the list of available end-of-use options for the item all presented on a single webpage.

Thus, a comprehensive, coherent and exciting system for End-Of-Use consumer product support service is created with activities to be accessed, presented and managed all in one place. The online retailer or electronic commerce company that sold the item to the customer should host such a system to remove all friction. These services are great on their own. But they are not nearly as compelling if offered individually by various third parties. There is a quality to be gained by offering a system that is comprehensive in nature yet limited to the customers of the host electronic commerce company. Placing all options on single page already figured out for the customer to select from, makes it so easy that it becomes exciting. Having the system suggest one option over the others, makes this system even easier as the customer doesn't even need to look at the other option(s) if they don't want to.

How to present and display the Afterlife Options for an item as exciting offers or pitches.

Thus, the available End-Of-Use options can be presented to the customer in a format that sells/pitches each option to the customer. In other words, by structuring the option to read with the most exciting selling points presented first so that the customer can get an idea as to how beneficial each option is at a glance. The idea being that the system presents each option with its best foot forward—most beneficial aspect or most exciting selling point first. Money being transferred to the customer's account or having an Amazon Prime member family who would love to have it, are selling points. Ease of use is also a selling point, the idea that the customer can trigger work for the benefit of the environment or for his/her fellow man with a simple click is a selling point. Each option should be presented in a format that quickly conveys to the customer the selling points of the option and the most exciting details the option offers upfront. If the receiving party is an Amazon Prime member or an Amazon Prime family, these are considered selling points. Money available for immediate use is an exciting selling point. This method of not just listing options but pitching them shall be referred to as presenting “options as offers” or “options as pitches”. The system pitches each offer to the customer by structuring the sentence with the bestselling points first.

The system structures the sentence used to describe the option with the best-selling point first in an effort to sell/pitch the option to the customer in the most exciting way possible.

For Example:

a) Sell it, to have $65 credited to your account for immediate use. Three Amazon Prime members would like to purchase your item.

NOT . . .

b) Sell it. There are three buyers who would like to purchase your item. If you select this option, payment will be made to your account in the amount of $65.

It is obvious that example B is not as exciting as example A. Example B takes too long to read and understand. Options benefits should be understood at a glance. The format should be as follows for each option. Using words like “Love” show and convey receiver appreciation. When listing a dollar amount, round down to the nearest dollar to keep it simple. No one will be upset when they find out it's $203.67 that they got and not $203. Use the word “advanced” instead of “loaned”. Use the word “cover” instead of “pay for”

Sell it, to have $______ credited to your account for immediate use.

Give it Away, a (local) (Prime member) (family) would love to have it. (They can pick it up.) (A pickup time can be scheduled.) (Or, we can transport the item.) (They are willing to cover shipping costs.)

Donate it, ______ would love to have it. (They can pick it up on (Thursday).) Tax write off documents for the donation would be sent to your email.

Rent it, to have $______ credited to your account for immediate use for starters. (Three prime members would like to rent your item at $ per day.) (Each are willing to pay for shipping back and forth.) (We can help with scheduling.) (The first borrower would like to know if they can pick it up on (Wednesday) to be returned on (Friday).)

Trade it, for a(n) ______—One Amazon (Prime) customer would like to trade or swap you their ______ for your item. Otherwise, your item would be listed as available for trade or swaps. You can also try to trade or swap it for something you like with other Amazon prime customers on Afterlife Swaps:

Lend it, to ______ (your neighbor), (an Amazon Prime member), who would love to borrow it. She can pick it up on (Thursday). (Or, if you'd prefer, we can transport the item back and forth. The borrower is willing to cover all fees.)

Pawn it, $______ can be advanced to your Amazon account for immediate use. Your item would be held for (35) days at a local Amazon Pawn facility. If you pay $______ within (35) days, the item will be returned to you. Otherwise it will be resold.

Recycle it, We can pick this item up and get it to a local recycling facility for you.

Or, you can drop it off at ______ located ______ miles from your home on (Saturday, February 16th 10:00 am to 6:00 pm).

Dispose of it responsibly, we can (have this item picked up for you and sent to a local recycling facility.) (have this item picked up for disposal.) (Would you like to schedule a pickup?)

The Afterlife PROGRAM restated with additional details . . .

Create the List of items purchased by the customer and optimize said list for displaying on the user's Afterlife webpage. Here's how . . .

Make the item list.

Access the user's archived order history from the Amazon customer database. Pull product, names, descriptions, stock photos, details, reviews and comments from the product information stored in the Amazon customer and inventory databases.

Organize “The Item List”.

Use the date of purchase from the order history to determine how old each item is. Access online marketplaces to determine trending used prices for each item or “items like each item” assuming the items are in good condition. Reduce the prices by a preset percentage or ease-of-use factor (say 25%) and subtract Amazon's transactional operating fees. eBay takes 10% of the sale but on eBay the user does all the work. List items in order of value based on these reduced prices. Check to see if any standing bids are available from buyers in the Afterlife Market for each item or “items like it”. List the items ranking the most valuable items at the top and the least valuable items at the bottom. If items have the same value or zero value, list in order of the purchase date from newest to oldest. Rank highest value items having at least one standing bid buyer at the top of the list followed by the highest value items without a standing bid. List items that have historically sold quickly on Amazon new or used as being considered more desirable.

Customer can help organize list.

The Customer can “Take Inventory” by manually removing items they no longer possess from their list. The remaining items will be ranked in order from most valuable and in-demand (having one or more bids) down to least desirable. Having more than one bid means it's more in-demand than having just one bid or no standing bids. Once the customer is no longer in possession of an item as a result of the customer initiating an Afterlife Option, the item is removed from the Afterlife list and moved to the Afterlife “Ghost” list to keep a record of items the customer got rid of. The Ghost List shows all the products that the customer is no longer in possession of.

It would also be within the scope of the present description to display the Afterlife Options that are available for each item next to or beneath each item for easy access. But this method does not allow the user to review all Afterlife Options at once and their respective outcomes on a single page in one step.

Determine Item Condition

If the user selects an item, the system will check the item and the customer info to determine if it's necessary to ask any condition questions and if so, which questions. If condition questions are to be asked, the customer will be asked to answer one or more questions to determine what condition the item is in. Some of these questions, if more than one, will be product specific questions based on the product information stored in the Amazon inventory database. This may include very specific questions to determine if the product had experienced a known point of failure that is typical of the item in question. A product's point of failure is usually revealed in the product's consumer reviews and comments section stored on Amazon's inventory database. Questions may include . . .

1. What condition is it in? Like New. Good. Poor.

2. Is the screen scratched? (Asked of the item has a screen)

3. Does the item function. (Asked if relevant to the item)

4. Do you have the power cord? (Asked only if the item requires a power cord)

5. Do you have the remote for it? (Asked if the item came with a remote)

6. Did the ______ disconnect from the ______? (This type of very specific question would be pulled from the consumer reviews and comments section posted on Amazon's current or old product page to get at the source of a potential product failure or to determine if parts need to be ordered and shipped along with the item to the buyer.)

7. Did you register the item with the manufacture? (If not Afterlife can help with that too.)

Once the condition for an item is known by the system it will recalibrate the customer's item list based on the updated worth or value of the item.

Generate and Display the Afterlife Options for the selected item.

Afterlife Options may include some or all of the following options. Show the Afterlife Options in this specific order with “Sell it’ listed first, followed by “Give it Away” as the 2nd option. The third option should be “Donate It”. The last options listed should be the item specific waste management options, “Recycle it” and/or “Dispose of it responsibly”.

1. Sell it.

2. Give it away.

3. Donate it.

4. Trade it.

5. Rent it.

6. Lend it.

7. Pawn it.

8. Revive it.

9. Recycle it.

10. Help dispose of it responsibly.

Newly bought items that can still be returned because their respective return periods have not yet ended will be included on the list for continuity. These items will show an additional Afterlife Option called “Return it”. Amazon may decide not to list newly bought items on Afterlife until after their respective return periods have ended. This is ultimately a business decision.

The program goes through each option for each item to determine which set of options should be made available for the item in question and which of these options should not be made available. Some items will have all of these Afterlife Options available. Some will not. It depends on the item and when the Afterlife Options were opened. As in life, some options change with time.

1. Determine if the “Sell it” option should be made available.

Salvaging money from an item for the customer so that he/she may put it toward future purchases is the top priority and is the option that offers the consumer the most personal benefit. And for that reason, it is the first option listed. But, not every product is worth selling. The system determines the item's value and identifies if the item is worth selling based on trending used sales prices for the item or “items like it” online and on marketplaces like eBay. It also checks to see if any standing bids exist for the item or “items like it” within the Afterlife Market and the value of the highest standing bid offer at that time. If the value of the item is less than it costs to ship, it is deemed not worth selling and the “Sell it” option will not be made available for the item and the “Sell it” option will ghost, becoming lighter in color and will not be clickable. However, if the item's value is found to be greater than the estimated shipping cost, the item is deemed worth selling and the “Sell it” option would be made available. In this case, the “Sell it” option would be bold and clickable.

If the condition entered by the customer during the condition questioning is less than what has been set as an acceptable minimum level for the product by either the system or a buyer who placed a standing bid for the item or “items like it”, the “Sell it” option is made unavailable. If the condition is acceptable, the “Sell it” option remains active and the customer can proceed with the sale.

If a standing bid exists for the item or “items like it”, the amount of money that would immediately be credited to the customer's Amazon account if the option is selected would be shown. The original price paid by the user for the item when it was new could be shown next to this sale price to show relative context. If the item is missing parts (remotes, power cords, etc . . . ), depending on the value of the item and whether or not these parts are being sold on Amazon at the time, the system can order and ship these missing parts to the buyer of the item to arrive around the same time as the item being sold so that the buyer receives all necessary parts with ease.

The full sale amount may or may not be immediately available to the customer. Depending on the customer's account history (how much money they typically spend on Amazon, the types of products they buy, if they have a good history of selling used items with Afterlife, etc . . . ). In some cases the system may decide to only advance a portion of the sale immediately and the remainder would be credited when the package is received by the shipping carrier or the receiving buyer. A customer's financial info, employment info and education info may also be considered by the system if this information is accessible or if it is stored in Amazon's customer database.

If the customer decides to sell the item and click on the “Sell it” option, the sale is made and all or a portion of the money is instantly available for the customer to purchase new items with. A shipping label is created for the customer to print. The option of having the shipping label printed and sent to them in the mail is presented at an additional cost which would get deducted from the sale price. A folded box may be included in the mail with a printed shipping label. An option to have the item picked up without the customer having to pack it up or print a label may be presented. If selected, the customer can then simply leave it outside their door (Amazon Ring) or inside their home in their foyer near their door (using Amazon Key service) or in their garage (Amazon Garagio) or in the trunk of their car (GM or Volvo or other automobile).

Once the sale is completed, an email notification with transaction details is sent to the customer confirming the sale and showing the sale amount that was credited to the customer's Amazon account available for immediate use. The email may include instructions on what do next, if anything. If the item requires erasing prior to shipping or pick up, instructions will be sent via email on how to do that if necessary.

Note that the buyer of the item will know that they are the 2nd owner and that the original owner bought it on Amazon and that the item was not stolen. Because the 2nd owner bought the item through Amazon, they too will have access to Afterlife Options for the item when the item is no longer of use to them and on down the line, provided all transactions go through Amazon.

If there is any warranty or user manual for the item, the system will have that information stored in Amazon's Inventory Database along with the product information and will email that directly to the buyer. If any parts are missing, like remotes, power cords, etc . . . , the system will check to see if Amazon sells these parts, and if so, it will order and ship these parts to the buyer so that the buyer receives the used item along with the replacement parts around the same time. So, essentially the system not only facilitates the sale, it also serves to partially revive the used item by making sure it sends all the parts it needs to keep it functional for longer. The ability for the system to sell and send missing parts for items separately, may cause an increase in the number of parts made available through Amazon by sellers as this will generate more business for providers of replacement parts (remotes, power cords, batteries, chargers, filters, etc . . . ).

It's okay if an item is missing parts. The system just takes care of it for them. It orders and ships the missing or broken part separately to arrive around the same time as the item. Typical replacement parts would include remotes, power cords, batteries, chargers, filters, etc . . . .

If there are no existing bids for the item or “items like it” at the time when the customer selects “Sell it”, the item does not qualify for instant sales and will be placed for sale on the Afterlife Market.

Buyers and sellers can be kept anonymous. No evaluative feedback between the two parties.

The “Sell it” option allows the customer to quickly salvage money from the item. If the item is not worth selling because the market value of the item is too low or the amount willing to be paid is less than the cost to ship, this option will not be available for this item.

Instant Sale—A sale can be made the instant the user selects the “Sell it” option if the system has a buyer with a bid in for the same item or “items like it”. The amount that can be immediately credited to the customer's Amazon account would be shown. The incentive for a user to place a standing bid, is to get a great deal below market value on the item. The incentive for a user to place a standing bid on “items like it” is to get a great deal below market value on a product like the one they are looking to buy. Exact item matches are placed at higher priority as they can get more money for the seller.

A “How to sell it at End-of-Use” section should be added to each item's product information stored on Amazon's inventory database. This section would help the system determine how to best price the item at End-Of-Use.

The “Sell it” option puts Amazon into the used item business, scheduling and helping its customer's move their items to others. First Amazon sells the item to the customer, then it helps them sell it to other Amazon customers. With this system, Amazon can make selling used items so easy that eBay takes a loss.

2. Determine if the “Give it away” or “Gift it” option should be made available.

The term “gift it” may be better than “give it away” as “Gift it” gives the giver a warm fuzzy feeling like they are giving a gift to someone and not giving away the farm. Anyway, the Afterlife program then goes on to determine if the “Give it away” option should be made available for the item in question. The answer is always yes. One man's trash is another man's treasure. If someone wants, they can have it.

If the item is missing parts such as a remote or power cord and Amazon sells these replacement parts, the Afterlife system will list this information with the item up for grabs and attempt to upsell these replacement parts to the taker to help him/her revive the item.

Don't throw it away. Give it to someone who wants it. Some people put it out front in the trash and hope someone sees it and takes it before the trash collector comes. That's not good enough. We can do better than that.

Even if the “Sell it” option is available and the item is in fact worth selling, the customer may still opt to “Give it away” instead. I think more people might opt for this “Give it away” option if it were called “Gift it”. Or maybe “Gift it” is something else where the item is wrapped and given to people in need or to underprivileged children during the holidays.

Once the condition is known and the missing parts, if any, are noted, the Afterlife system checks the Afterlife Market to see if there are any FREE standing bids for the item or an “item like it” are available. A FREE item standing bid order agrees to pay for shipping or transport. If no standing bid for such a FREE item exists, the system will post the item as available for FREE, provided that the taker agrees to cover shipping or transport costs or pick it up and Amazon's transactional operating fee. The item would be presented just as if it were for sale for $0. If enough people participate the transaction should be instant. The Taker posts that they would pay to cover shipping or pick it up if locally. If the giver (the customer) does not want the taker to come to their home to pick it up, they can drop it at an Amazon drop location for the taker to pick up there at a different time. Or the Giver can opt to only allow for shipping or Amazon pick up which the taker would have to agree to pay for.

The “Give it away” option allows the customer to have the system find someone who wants the item and is willing to pay to have the item sent to them. If no one is willing to pay to have this item sent to them or no one is willing to pick up the item either at your home, or a drop to pick up location, this option will not be available for this item.

If Afterlife has a compelling taker such as family who would really love to have the item, the customer may feel compelled to forgo selling the item and just give it away to the family who really wants it. It's ultimately up the customer to decide what they want to do with their item.

A “How to Give it away” section should be added to each item's product information stored on Amazon's inventory database. This section would help the system determine how to best to give the item away at End-Of-Use. A list of potential taker types and demographics of Amazon users to show this item to at End-of-Use. Details such as what condition question(s) to ask to determine if parts are missing should be stored and found in a “Condition Questions” section in each item's product information on Amazon's inventory database.

The “Give it away” option puts Amazon into the 2nd hand supply chain business, scheduling and moving items between its customers, vintage 2nd hand stores and thrift shops. First, Amazon sells the item to the customer, then Amazon helps the customer find a new home for the item, keeping the item in use and out of landfills.

3. Determine if the “Donate it.” option should be made available.

The program then goes on to determine if the “Donate it.” option should be made available for the item in question.

Afterlife determines what type of item it is, whether it be books, clothes, coats, toys, furniture, or food and matches your item with an appropriate local charitable organization to take it. It checks for local thrift stores, churches and children's hospitals, where others can enjoy it.

The system checks to see if a local charitable organization or church would be interest in the item based on a subset of factors. The system checks to see if any requests were made by local charitable organizations for your item or items like yours. If the “Donate it” option is selected, an email is sent to the customer to confirm the donation was made along with the necessary documents to qualify for a tax deduction when and where applicable. The system will contact the local charity to arrange for pick up.

Backpacks—The American Birding Association is accepting donated backpacks. americanbirding.org. Without a program like Afterlife, how would people ever know that that is an option for their item if their item is a backpack at any given time. Software that automatically connects giver opportunities with takers opportunities is needed and easy to do especially at Amazon with their scale and reach.

A “How to Donate it” section should be added to each item's product information stored on Amazon's inventory database. This section would contain stored information to help the system determine how to best donate the item at End-Of-Use. This information may include any item specific tax code information, etc . . . .

The “Donate it” option allows the customer to have the system arrange to have the item picked up by a local charity or offer relevant local drop off locations for the item. It can prepare the necessary paperwork required to submit for a charitable donation tax write-off. These documents are emailed to the customer and made available for download on Amazon Afterlife.

No more researching and making calls and driving around looking for drop off bins.

The “Donate it” option puts Amazon into charitable giving business, scheduling and moving items between its customers, vintage 2nd hand stores and thrift shops and charitable organizations. First, Amazon sells the item to the customer, then Amazon helps the customer find a new home for the item, keeping the item in use and out of landfills. This may be an opportunity for Amazon to receive a tax credit for these humanitarian efforts.

4. Determine if the “Trade it.” option should be made available.

The program then goes on to determine if the “Trade it.” option should be made available for the item in question. All items are tradable and swappable with other customers who are looking to swap their item(s) for other item(s). Marketplaces like this currently exist supposedly. So, it's just a matter of setting that kind of marketplace up within the Afterlife system. Traders would list the item(s) they are willing to trade and the item(s) they are willing to trade it for. Traders can send messages to each to make offers for potential trades and swaps. They can then dicker with each other—Amazon Dickering (https://www.youtube.com/watch?v=KB1Ad4GLefk).

A swap is when one customer swaps an item for another item. A trade is when a customer trades one or more items for one or more items from another customer. Amazon collects a fee for facilitating each trade or swap and will assist in transporting the item(s). Trading and swapping items between Amazon customers is fun and would keep Amazon on people's minds.

The idea is to create a marketplace online for Amazon customers to trade and swap their items with each other. It's the trading and swapping Amazon Afterlife Option only available to Amazon customers.

5. Determine if the “Rent it.” option should be made available.

The program then goes on to determine if the “Rent it.” option should be made available for the item in question.

The system connects “ItemLords” with “Renters” in the same way it connects “Sellers” with “Buyers”. But, instead of purchasing the item, the Renter agrees to pay per day, week or month of use. The renter covers the cost to transport or ship the item back and forth. Or, the “ItemLord” may allow for pick up by the Renter to save the renter some money.

The money paid by the Renter is credited to the customer's Amazon account and may be used for more Amazon purchases.

If the renter loses the item or does not return the item, the renter will be charged for a new replacement item being sold on Amazon. The ItemLord would be credited this amount and can decide to use that money to either buy a new replacement item, keep the money or purchase something else on Amazon.

This option is great for tools, ladders and yard equipment. Instead of buying a lawnmower, one could be rented for a day every two weeks.

The “Rent it” option puts Amazon into the rental business, scheduling and moving items between its customers. Amazon can be in the business of renting out their customer's items to other Amazon customers. First, Amazon sells the item to them, then Amazon helps the customer rent it to other Amazon customers. This could also be a lucrative side business for Amazon customers to earn money from essentially lending out their items. Amazon would handle everything from scheduling, billing, transport to collecting payment, late fees or lost payment(s). Amazon can even help the customer revive the product to keep it up and running and earning money for both the customer and Amazon. “Could be a nice way to earn some extra cash for you”, would be the pitch to customers.

A “How to Rent it” section should be added to each item's product information stored on Amazon's inventory database. This section would help the system determine how to best to rent the item out at End-Of-Use. This information may include any item specific information that a renter might want to know about the item, etc . . . .

www.AmazonRentals.com

6. Determine if the “Lend it.” option should be made available.

The program then goes on to determine if the “Lend it.” option should be made available for the item in question.

Afterlife enables customers to make their item available to others to use locally or otherwise for FREE. The borrower would pay for shipping or transporting the item back and forth and an Amazon transactional fee. The Lender may allow for pick up to save the borrower some money.

The system connects “Borrowers” with “Lenders” in the same way it connects “Sellers” with “Buyers” on the Afterlife Market.

“Lender” offers and “Borrower” offers are listed on the Afterlife Lender Market webpages. The system checks for local Amazon customers in your area who would be interested in borrowing your item first. This option is great for tools and during a state of emergency. The borrower does not pay the lender. But they do cover shipping costs, or they would need to pick it up if allowed by the Lender. Amazon can arrange to pick it up from the Lender and deliver it to the Borrower and back for a fee to be paid by the borrower. The Borrower may need to pay for the transport or shipping of the item. Borrowers and Lenders can be kept anonymous if that is what the lender would prefer. Typically, Lenders do not want to keep things anonymous. They would like to know who the Borrower is. If the borrower loses the item or does not return the item, the Borrower would be charged for a new replacement item being sold on Amazon. The lender would be credited this amount and can decide to use that money to either buy a new replacement product, keep the money or purchase something else on Amazon.

This option is great for tools and distant neighbors separated by more than one block. This is particularly useful in a state of emergency and/or a natural disaster or just an opportunity to practice the golden rule and be a good neighbor.

Lending is not limited to just local participants. Items can be lent between Amazon customers located in different towns, states or countries.

Amazon stands to make money from transaction fees, transport fees, replacement item sales and lost item fees paid by the borrower.

A “How to lend it” section should be added to each item's product information stored on Amazon's inventory database. This section would help the system determine how to best lend the item at End-Of-Use. This information may include any item specific information that a lender or borrower would want to know about the item, etc . . . .

7. Determine if the “Pawn it.” option should be made available.

The program then goes on to determine if the “Donate it” option should be made available for the item in question.

If you'd like to buy something on Amazon but, you don't have enough money or Amazon credit to do so AND you have a item of value that you bought from Amazon, Amazon can lend you 35% of the used product's market value to put towards the purchase of a new Amazon product you want. You would send your used product to Amazon to hold for you for 1 month. If you pay back the loan with interest within the one month timeframe, Amazon will send you back your used item. If the month passes and the loan is not paid, Amazon will keep the item and resell it for profit to someone else.

pawngo.com can be used as a template for this service. Maybe the items are sent to them to hold?

The “Pawn it” option puts Amazon into the Pawn business, scheduling and moving items around and collecting interest. First Amazon sells the item to them, then it helps them use the item to secure a loan that can be immediately put toward Amazon purchases.

A “How to Pawn it” section should be added to each item's product information stored on Amazon's inventory database. This section would help the system determine how to best pawn the item at End-Of-Use. This information may include any item specific information that would help the system Pawn the item more efficiently such as whether or not the item is one of a limited edition or to ask if the item is signed by a celebrity along with a process for how that can be verified through an autograph verification service like https://www.psacard.com/services/autographauthentication, etc . . . .

www.AmazonPawn.com

8. Determine if the “Revive it” option should be made available.

The program then goes on to determine if the “Revive it” option should be made available for the item in question. The “Revive it” option allows the customer to have the system help them restore the item and bring it back to life and get it working again.

For Example . . .

My Smoothie Machine blender glass broke. “Send me a new glass jug for it.”

Either the system gets in touch with the manufacturer on behalf of the consumer to find out the part number OR all of the part-numbers for the item are listed (or should be listed) within the product information stored in Amazon's inventory database OR the system checks its inventory for a replacement part for the customer's item. If Amazon is selling this part, they will sell/send it you. If the repair is more difficult than just replacing simple parts like remotes, filters, batteries, power cords, or glass jugs, the system will connect the customer with a local repair service or will arrange for the customer to send the item to an Amazon facility for repair. Amazon can also offer to pick the item up without any packaging to save the customer from having to drive, box, pack or label the item.

A “How to revive it” section should be added to each item's product information stored on Amazon's inventory database. This section would help the system determine how to best revive the item at End-Of-Use.

The “Revive it” option puts Amazon into the spare parts business in a bigger way, ordering/shipping replacement parts to its customers more easily than before. Keeping products working longer is a good thing they'd be doing and it's another way to keep Amazon on people's minds. This may blossom into a repair business for Amazon for certain items. First Amazon sells the item to the customer, then Amazon helps the customer order replacement parts for the item from them with unmatched ease.

9. Determine if the “Recycle it.” option should be made available.

The program goes on to determine if the “Recycle it.” option should be made available for the item in question.

Most people do not know if their item can be recycling or where to send or bring the item. They don't know anything about recycling beyond maybe the disposable paper, plastic or glass recycling that may or may not be offered by their waste collector.

It is possible for the system to know the details of the recycling program offered to the customer by his/her existing waste management provider based on the customer's home address.

Afterlife can access websites like Earth 911 (https://search.earth911.com) to look-up recycling centers for the specific item in question. Afterlife determines the item type from the known product description and the known zip code of the customer from the Amazon customer database. The item type and zip code of the customer is entered by Afterlife at https://search.earth911.com to locate an appropriate recycling center.

Advances in recycling offer more options now than ever and new programs and technologies for recycling are constantly being added. Software that keeps up to date with the latest and best eco-warrior practices with respect to each item is needed. Customers are not willing to spend time to learn and navigate the changing field of recycling and recycling issues.

Afterlife matches the customer's item with an appropriate recycling program local or otherwise for least environmental impact. If a recycling program is not available for the item or the recycling opportunity would do more harm than good for whatever reason, the recycling option will not be available. In this case, the customer will be directed to the “Dispose of it responsibly” option below it.

Many items can be recycled that people don't expect. The Afterlife system will see what category the item fits in. Some categories include electronic waste, paint and pesticides (Aerosol cans), power tools, Smoke Alarms, Light bulbs, batteries and car batteries. If it's an electronic device, it can be picked up and sent to an e-waste processing facility. For other categories it would be sent to the appropriate recycling center.

“Unwanted electronics can't be mixed with other recyclables but are easy to recycle through other options. Electronic waste includes, Televisions, Computers, Computer components like keyboards, monitors, and mice, CD/DVD's, Blu-ray players, Printers, copiers, fax machines, Cell phones and home phones, Microwaves, Refrigerators . . . And more.”—(copied this from WM.com))

(Amazon Afterlife) “ . . . would work closely, and diligently, with you to help keep your community safe by keeping these potentially harmful products out of the trash. Carefully and safely dispose of home electronics. One of the fastest-growing sources of waste, electronics waste or ‘e-waste,’ must be carefully managed to avoid potentially dangerous components from hurting the environment. There are many chemical and mineral elements in e-waste. A circuit board contains copper, gold, silver, platinum and palladium, as well as lead. If recycled properly, this waste is a valuable source of secondary raw materials. Prevent e-waste from entering municipal incinerators or landfills; prevent the export of e-waste to developing countries; providing visible tracking of e-waste throughout the product recycling chain. Microwaves, Smoke Alarms/Detectors, Fire Alarms/Detectors Thermometers, Large Appliances (Refrigerators, etc.), Non-Decontaminated Medical Equipment, any unit with Sludge or Liquids”—(copied this from WM.com))

The Afterlife system checks to see if the item in question is a good fit for any of Afterlife's preset or searched online (earth911.com for example) recycling opportunities. Recycling opportunities and item qualification details are programmed into Afterlife and updated frequently by Amazon's team of eco-warriors and nonprofit recycling organizations. If Afterlife identifies a recycling opportunity that can take the item, it will arrange to have the item or items picked up. Or, depending on the item and the location of the recycling opportunity, it can send the customer a flat folded box with a shipping label. The customer would simply place the item or items in the box and place the label on the box—no fill packing is necessary because it is okay for the item to get damaged during transport. The box would be picked up by UPS and would go to a processing facility to ensure that the item is safely recycled.

The system can also suggest item specific local actives that a customer can do to recycle an item. Such as, suggesting the customer . . . “Drop off your old car battery at your local gas station or mechanic garage to have it recycled (the battery core may be reused.)”

The system removes the need for checking local recycling programs to see if the type of plastic used to make the item is recyclable in your area. Putting the wrong plastics into a recycle collection is damaging to recycling facilities. So, most people don't recycle because it's too difficult. But the system already knows what material the item is made of because that information can be stored and found in the item's “how to recycle” section of its product information. And, the system already knows which recycling facility is most appropriate.

A “How to recycle it” section should be added to each item's product information stored on Amazon's inventory database. This section would help the system determine how to best recycle the item at End-Of-Use.

Calling a recycling facility only to find out that it is closed, is a waste of time and another reason people don't recycle. The system can check to verify that the appropriate recycling facility is in fact still open and active before offering it up to the customer as an Afterlife Option.

Amazon may also suggest a local electronics drop-off center or a local Electronics Drive if one is coming up in the near future and can ask if the customer is inclined to dropping it off themselves. Otherwise, Afterlife will make the necessary arrangements to have the item picked up or will help the customer ship the item buy supplying a shipping label and a flat folded box if necessary. No fill packing is necessary.

Pain points include:

A. Many recycling centers are available only to local residents. This makes the independent search more difficult and places potentially unnecessary distance between the customer and an appropriate recycling facility.

B. Different recycling centers accept different item types, adding difficulty to finding the right facility for the customer's item.

C. Some recycling program are municipal and some are mail-in programs. It gets confusing.

“We all know that we should recycle, unfortunately knowing where or how to recycle it isn't always so intuitive.”—https://www.personalcreations.com/blog/how-to-recycle-anything

Websites like https://www.personalcreations.com/blog/how-to-recycle-anything demonstrate the mess of recycling. It shows how much thought it takes and how difficult and overwhelming the task of recycling can be. It offers great insight into all the different recycling options available that no-one bothers to know or think about.

Software can sort this out with a click.

Example . . .

The system can greatly simplify the recycling process. The following is a suggestion made on an eco webpage for how to recycling a Car Seat.

Car Seats

If your car seat has never been in an accident and is less than six years old, consider passing it on to someone else. Some areas have car seat recycling drop-off centers. If not, you can take the seat apart and sort it yourself, but first make sure your local recycling facility accepts the disassembled parts.

Instead, the system can ask the user in the preceding condition questions, if the car seat was ever in a car accident and if the car seat is less than 6 years old to determine if the “Give it away” Afterlife Option should be made available. These condition questions would be stored and found in the item's product information of Amazon's inventory database.

Despite whether or not this item can be given away, the system would still determine if there is a car seat recycling center within an acceptable distance (too far may do more harm than good) and can offer to schedule to have the item picked up with a single click. Or, it will find an appropriate recycling facility that is willing to take the entire car seat as is and have the time transported to them. If the only way to recycle the car seat is to disassemble it, then that is the Afterlife Option that would be presented. However, the goal of the system is to present the easiest recycling option possible to help keep the item out of a landfill. Remember that the recycling option is the last line of defense against the customer simply throwing the item in the trash. So the option better be good and easy.

Example . . .

Compact Fluorescent Light Bulbs

The Home Depot offers free CFL recycling in all their stores. Some bulb manufacturers and other organizations sell pre-labeled recycling kits that allow you to mail used bulbs to recycling center

Did you know that? I didn't.

But, the system would know because that information would included in the product's info stored in the “how to recycle it” section of Amazon's inventory database. The system also already knows where to have the bulbs sent and can make the arrangements to get the item there. The system may also suggest that the customer could also drop the item at their local Home Depot Store as Home Depot offers free CFL recycling in all their stores.

More examples . . .

Cooking Oil

The system can consult Vegoilrecycle.com to find a location that will recycle the customer's vegetable oil for use in the renewable energy industry.

Crayons

The system can arrange to have your crayons sent or dropped off with the Crayon Recycle Program that accepts unwanted, rejected, broken crayons and recycles them into fresh, new crayons! The program has drop-off bins nationally.

Engine Oil

The system may suggest the customer drop their used oil and oil filters at retailers such as AutoZone and O'Reilly Auto Parts. The system also has access to Environmental Services at 858-694-7000 and website to find other private businesses that will recycle it properly. The system could arrange to have this picked up with a single click.

Denim

The system can arrange to have your used denim clothing item(s) sent to the Blue Jeans Go Green recycling program, where they will recycle it into denim insulation for civic buildings and new homes in communities that need it most.

Yoga Mats

The system can suggest or arrange have the customer's yoga mat item sent to RecycleYourMat.com for recycling.

Hard Drives

The system may suggest dropping hard drives and items containing hard drives off at the customer's local Best Buy or Staples as both are accepting hard drives and items containing hard drives for recycling at the time this option is offered. The system may also suggest donating this item to the Data Rescue Center in the “Donate it” Afterlife Option.

If the system suggests an activity such as a drop off location where the customer would go to drop the item off for recycling, the distance from the customer's home to the drop off location is presented in the “Recycle it” Afterlife Option and outcome estimate to help the customer decide if that activity is for them. The system always suggests the simplest option first and may offer an addition secondary option that has less environmental impact but would require more effort from the customer such as dropping an item off themselves as opposed to mailing it in or having the item picked up by Amazon. Easiest it best and presented first because each option is competing with the ease of simply throwing the item in the trash. Keeping these items out of landfill is priority number. If the customer is willing to put in a little more effort, they can try the secondary more ecofriendly recycling option.

The system also checks to see if the customer's current waste management provider can recycle the item for them.

10. Determine if the “Dispose of it.” option should be made available.

The program then goes on to determine if the “Dispose of it.” option should be made available for the item in question.

Proper disposal is important especially when dealing with certain items like lead acid batteries, etc . . . . Disposal is the least desirable option listed and should be avoided. We don't want to add trash to our landfills. However, if no better option is available for the item in question, the system will advise you using the best eco-warrior practices in combination with disposal information stored in Amazon's Inventory Database as part of the product's information for disposing the specific item in question. Toxic materials and chemicals must be disposed of properly. Doing so otherwise, is not just unethical it is illegal. The system may contact your local (it knows where you live) trash collector and notify them of the pick up. Or, you can have Amazon pick it up for you. Or, Amazon can hire a local contractor to pick it up for you. Amazon can make scheduling trash removal extremely easy and satisfying. Amazon can help make sure your trash goes to the right place(s).

If the system can offer a better solution than suggesting the customer throw the item in the trash, it will simply say . . . “We can have this item picked up for you and sent to a local recycling facility.” no muss no fuss.

A “How to Dispose of it Responsibly” section should be added to each item's product information stored on Amazon's inventory database. This section would help the system determine how to best dispose of the item at End-Of-Use. This information should be continuously updated by Amazon Eco warriors and the item's manufacturer.

The system will also check to see if the customer's current waste management provider can recycle the item for them.

11. Determine if the additional “Return it” option should be made available.

The program then goes on to determine if the “Return it.” option should be listed and made available for the item in question.

Newly bought items that can still be returned would list the “Return it” option. Amazon may decide not to list newly bought products on the Afterlife List until after their respective return periods have ended.

12. Determine if the additional “Buy it Back” option should be made available.

If the system does not have a waiting buyer (a standing bid) for the item and the margins are good for the sale of the item and the item sells regularly, Amazon may offer to buy the item back at a discount from the customer. This option would probably be so rarely offered that it isn't included in the list of 10 main Afterlife Options.

Inventory Database will request additional information going forward.

When new products are added to the Amazon inventory database either by Amazon, by manufacturers, sellers or retailers, additional information should be included along with the typical product information. This additional information is meant to better inform and serve the Afterlife system as to how to handle the product in Amazon Afterlife. Newly added products should include the following additional product information such as . . .

1. A complete parts list with model numbers.

2. Manufacturer registration information. How to register the product and warranty information.

3. Manufacturer's Help hotline, contact information, phone number and email, etc . . .

4. Best practices for recycling the item.

5. Best practices for disposing of the item.

6. Questions designed to determine if the product is still active.

How buying these used items works . . .

People who would like a chance to buy used items from existing Amazon customers at less than market value, may do so on the Afterlife Market webpages. There are two ways a person can purchase these used items.

1. A person can shop on the Afterlife Market webpages for these used items just as they would for used books on Amazon.

2. For even better deals and to insure they get a desired item, people can place a standing bid order for a specific item or “items like it”. “Items like it” are comparable items and could include similar items made by different manufacturers. A buyer would select the “items like it” option if they want an even better deal on the item and they don't care which company (or manufacturer) it's made by. They can also select which manufacturers they are willing to accept. These standing bids are what make it possible for Amazon customers to sell their used items instantly because the buyer has already placed a waiting buy order for the item. These orders are filled on a first come first served basis unless a buyer has placed a higher bid in which case the highest bid wins. Many buyers could place standing bids on the same items. Buyers would line up because they can't get a better deal and not nearly as easily on other used marketplaces like eBay.

Buyers can place a bid for the exact item or they can select “items like it” to save even more money and get potentially quicker fulfillment. Buyers can set a minimum acceptable level for what condition the item can be in. The lower the condition level, the lower the bid. Bids are preset and determined by the Afterlife system to avoid any bids being too low. The buyer is welcome to over bid or bid higher than the Amazon offered minimum preset bid to give themselves a better chance of getting the item. The bids are based on the trending value of the item less an Amazon convenience and processing fee. It is further discounted below market price to incentivize placing a standing bid in advance. If enough people participate, standing orders should fill and execute very quickly. The more people who use this system, the higher the likelihood for more instant sales on both ends.

Reasons to buy used items on the Amazon Afterlife Market include.

1. You know you are buying from the original owner and that the item was newly bought on Amazon. The original owner bought it new on Amazon. You get a complete product history and a complete Amazon Pedigree, including all relevant purchase dates and general product locations (where the products lived—nothing too specific to protect the personal information of owners). Buyers will also know if the seller is an Amazon Prime member or not. The idea being an Amazon Prime member is more committed to the Amazon ecosystem and is therefore more apt to be a better supporter of the system and be a better more cooperative participant. You can see if the item was ever revived and which, if any, replacement parts were ordered for it. Buyers and sellers are kept anonymous. eBay user accounts are not credible. Amazon user accounts and Amazon prime member accounts are much more credible. Amazon users are real people who can be held accountable by Amazon. It will be clearly noted if the seller is a 2nd owner who bought it from the original owner on the Afterlife Market or a 3rd owner who bought the item from a 2nd owner on Amazon Afterlife who bought it from an original 1st owner who bought it new on Amazon and with all the purchase dates.

2. You know the product is not fake.

3. You know the product is not stolen.

4. You'll receive all parts necessary to use the item, including any missing parts like remotes and power cords etc . . .

5. You'll receive the information you need to register the item with the manufacturer

6. You don't pay tax.

7. You'll receive any relevant warranty information.

8. You'll receive a hard copy or digital copy of the user manual.

9. You'll be given the Original Purchase date as made by the original owner new, so you'll know exactly how old the item is.

10. You'll have access to Afterlife Options when you no longer find the item useful.

11. Buyers and sellers can be kept anonymous.

12. No evaluative feedback between the two parties.

If buyers and/or sellers wish to be kept anonymous, this can be achieved by using Amazon as the middle man. The customer would send the package to a local Amazon facility or drop location or Amazon would pick the item up at the customer's home (outfront, inside foyer or garage), or trunk of their car. Amazon would then forward the item to the buyer. This way, the customer would never have access to the buyer's name or shipping information and the buyer would never have access to the seller's name and shipping address as would be shown in the return address on the shipping label. eBay does not allow for this anonymity. When an eBay seller ships an item directly to an eBay buyer, he/she has access to the buyer's name an shipping information and the buyer has access to the seller's name and shipping address as shown on the shipping label as the return address.

An instantiation of the present example includes software that steps through the following processes in the order as follows.

1. Generate item list.

2. Generate customer's Afterlife webpage displaying item list.

3. Determine best Afterlife Options for the selected item.

4. Display condition question(s) for the item if necessary.

5. Display all Afterlife Options as offers for the item on a new webpage.

6. Schedule the selected option action and send email notification.

PRESS Release Example:

Amazon Afterlife—New Alexa Skill so valuable, you'll only shop on Amazon

Alexa, open Afterlife Options—is how it begins. That's how you'll enable the world's first all-inclusive end-of-use product support system if and when it gets certified by Amazon. Here's what it does . . .

Done with a product you bought on Amazon? Have Alexa sell it instantly. Or, have her give it away, donate it, trade it, rent it, lend it, pawn it, revive it, recycle it or help you dispose of it responsibly.

Gone is the headache of figuring out what to do with the old, so long as you bought it on Amazon. Alexa helps you decide which Afterlife Option is best for you and makes all the arrangements.

Amazon already knows everything about your item. All she might ask is “What condition it's in?” (Cue music—“What condition my condition is in” by Kenny Rogers and the First Edition.)

You can actively sell your stuff on marketplaces like eBay over time. Or, you can passively sell your old Amazon stuff in an instant. That's a killer incentive to buy everything on Amazon. It closes the loop.

Listen to the audio demo of me using my Afterlife Options to “sell” the guitar I bought on Amazon . . .

If this Alexa skill is approved by Amazon, Afterlife Options would add value to every Amazon purchase and extend the life cycle of the products Amazon sells, bringing joy to more people, reducing waste and protecting our environment. Your Afterlife Options make it a breeze to quickly salvage money from your old stuff to put toward new purchases or get your used items to people who can use them and keep them out of landfills.

You'll also be able to view your Amazon purchased items listed in order from most valuable to least desirable on Amazon Afterlife. So, you can spot and get rid of things you don't use or need anymore.

Try the “Alexa, sell all my stuff” command. Great for moving or sorting out the Amazon bought belongings of someone who passed away. It sells what it can and gives away, donates and recycles what it can't. It can also schedule a pick up for disposal.

The idea being, buy on Amazon to keep your Afterlife Options open. Buy somewhere else and you're on your own. And remember, Amazon Afterlife is heaven.

www.AmazonAfterlife.com

AfterlifeOptions.io

www.WalmartAfterlife.com

Using Alexa's voice enabled system to access Amazon Afterlife.

An Alexa Skill called Afterlife or Afterlife Options can be used to access the Afterlife system on Amazon. A customer can ask Alexa to enable Afterlife Options by saying, “Alexa, open Afterlife Options.” if not already enabled. The customer can then tell Alexa which item he or she would like to get rid of by simply referring to the item as My (Noun). For example. My TV of My Guitar or My BLANK.

With Afterlife, Alexa thoughtfully handles all issues that arise when you're done with a product you bought on Amazon. When you're finished with a product you purchased on Amazon, Alexa can sell it, give it away, buy it back, trade it, donate it, recycle it or help you dispose of it responsibly, earning you Amazon credit in the process to put toward your next Amazon purchase(s). Amazon Afterlife by Alexa is another compelling reason to buy everything on Amazon as this service is only available for products you buy on Amazon.

Amazon's voice enabled system called Alexa can also access this list when asked by the customer. If Alexa does not yet have access to the customer's order history. An Alexa Skill workaround would be . . . Since Alexa does not have access to the customer's Amazon order history, she can ask for permission to parse the customer's emails, looking for Amazon Purchase Notifications to build the list herself. And/or, once enabled, she can build a list from products that the customer orders using Alexa going forward.

Instant sales—Alexa can make a sale instantly by connecting a seller with a buyer for popular (used) products in the Afterlife marketplace, like how market sell orders trade on the stock market. The items sell for the best available price at the time. Amazon Afterlife sets the minimum sell price at 40% of the current market price (this can be adjusted). This works because getting an instant sale for a used product that the consumer may have considered throwing in the trash, beats working to get top dollar for your used product. The Afterlife marketplace is built for high-speed passive selling of used products. Instant gratification beats leg work and waiting and having another thing on your mind. Buyers line up and love it because they get great deals. The buyer sets a minimum condition level and a price they are willing to pay equal to the minimum price or more to insure they are first in line. This method allows people to sell a used product instantly.

The Afterlife online marketplace enables users to passively sell used products instantly for the best available price at the time for when effortless speed is a priority over getting top dollar. Buyers line up to place buy orders because they stand to get a great deal, so the likelihood that there is a willing buyer for the item at any given time is high. A minimum buy order price is set to avoid an unacceptably low sale price.

It is an object of the present examples to enable a patron to passively sell their used product by simply asking the electronic commerce company's voice enabled device to do so. The following example demonstrates how this would work with Amazon as the electronic commerce company and Alexa as it's is voice enabled system with Afterlife Options.

Alexa can sell it.

### EXAMPLE #1

Customer says, “Alexa, sell my TV.”

Voice enabled system responds, “Okay, it's sold. I'll emailed you the details.”

### EXAMPLE #2

Customer says, “Alexa, sell my Electric Skateboard.”

Voice enabled system responds, “Okay, what condition is it in?

Customer says, “Like new. I barely used it.”

Voice enabled system responds, “Okay, it's sold. I'll email you the details.”

### EXAMPLE #3

Customer says, “Alexa, sell my couch.”

Voice enabled system responds, “Okay, I can sell it. But I have a Prime member family down your street that would love to have it. Would you like to give it to them?

Customer says, “Okay. Give away my couch.”

Voice enabled system responds, “Great! This will make them very happy. I'll email you the details.” (The receiving Prime member is encouraged to post a photo of them putting the couch to good use).

### EXAMPLE #4

Customer says, “Alexa, sell my Guitar.”

Voice enabled system response, “Okay. Your electric guitar?” (b/c it's their most recent purchase)

Customer says, “No, my acoustic one.”

Voice enabled system response, “Okay. What condition is it in?”

Customer says, “Pretty good. Everything works. It has a couple of scratches but nothing major.”

Voice enabled system response, “Okay. It's sold. I'll credit your account and email you the details” (Prime members with a solid history will receive the Amazon credit instantly if the amount is less than their allowed limit for advanced credits. Lie detection software can be employed to help Alexa determine if the customer is telling the truth or if he/she might be unsure about the condition he/she is claiming. This additional information is used to help determine if advancing the credit is higher risk.)

### EXAMPLE #5

Customer says, “Alexa, I'm moving. Sell all of my stuff and give away what you can't sell.”

Voice enabled system response, “Okay, I'll email you the details and I will help you recycle and dispose of the things that are unwanted.”

### EXAMPLE #6

Customer says, “Alexa, Fred passed away. Please sell all of his stuff and give away what you can't sell.”

Voice enabled system response, “Okay, I'll email you the details and I will help you recycle and dispose of the things that are unwanted.” (the email will require confirmations)

With the current examples, the consumer can passively have Alexa sell it for him/her. The consumer doesn't need to know the model number or worry about reviews or accounts or postings or negotiating or bids or emails from strangers or wait for it to sell or for the auction to end or learn marketplace platform rules, take photos or additional logins or payment methods or set-up time delays, pricing or descriptions or even be conscious of the sale(s), etc . . .

Proceeds from the sale(s) are quickly credited directly to your Amazon account. Amazon can profit from every transaction. Alexa may deem the product unsellable based on the product and the condition of the product. If unsellable, she will suggest other Afterlife Options based on product info, condition, manufacturer's promotions (buy the new model with a discount if you drop the old one in the mail type promotions), warranty's, and user feedback. She can also help you decide which Afterlife option is best for your situation.

Typical consumer responses used to describe the condition of the used product include: Not so good, Good, pretty good, Very Good, Great, Excellent, Perfect, Like New, Never Used, barely used, Never opened. Afterlife employs lie detection software. So, by answering the “what condition is it in?” question verbally, the system can determine if the consumer might be lying about the condition of the product based on voice patterns (a camera can be added to monitor body language). If the system thinks the consumer may be lying or unsure about what they are claiming, the system may not credit their Amazon account instantly. Stating verbally what condition your product is in tells the system more information than just typing the answer in or clicking a multiple choice button. This allows the system to make better, more informed decisions about the condition of the used product and the transaction overall. Verbally communicating the command also serves to partially verify the consumer's identity. If a women's voice tries to sell something that a man owns, it may not allow or support the transaction unless enabled to do so. Or a secondary method of confirmation may be required.

It is possible to make the sale instantaneous if one or more buyers are already registered (like a wedding registry) to buy your used product or is on a waitlist for such a product. Because the goal is not to get top dollar for the product, it sells at or below market value. The trick here, is not to care about getting top dollar for it. Remember, you need to put in time and effort to get that extra money. For many Amazon Prime members, it's not worth their time or the effort to get top dollar. So, the buyer stands to get a great deal and the seller gets a quick effortless sale for something they may have considered throwing in the trash. A financial stock exchange market order type marketplace is possible where buyers can place “buy orders” for a desired product or type of product for which they set the condition level (or level range) and the price they are willing to pay for it. So, when a seller wants to sell, the order is matched to the best available current price (like a financial Market Order) and the sale is made instantly. Amazon will set minimums to avoid selling it for less than 40% of it's market value (this % can be adjusted). Amazon will determine the market value based on the product details, age, popularity and the seller described condition it's in and comps. Alexa may ask you questions to help her determine what condition it's in. Amazon may decide to buy it back instantly themselves to relist it for sale at a higher price. Alexa may ask additional questions to better understand what condition your used product is in an effort to get you the most value possible. Because the electronic commerce company already knows everything about your product and history, buyers can have access to more product info than what is available on any other marketplace with zero effort on the part of the consumer.

Alexa can give it away.

With Afterlife, Alexa can arrange to give a used product away to a local Amazon Prime member (or Amazon Prime family member if enabled local or otherwise). It's a “who want's it” type Amazon listing or posting to local members and the world if enabled. It is possible to confirm this “give away” instantly if people are registered (like a wedding registry) or waitlisted as wanting for such a product. People can set the minimum condition level that they are willing to accept. Once the give away is fulfilled, Alexa will post your good deed to your Amazon profile and the recipient can post comments and photos of them putting your old product to good use. You can leave it outside your home for pick up. You don't need to be present for the pick up. You don't need to meet anyone. Alexa can schedule the pick up for a certain time and place. You can also schedule the pick up to be at a local Amazon Drop location.

### EXAMPLE #7

Customer says, “Alexa, Get rid of my kitchen table for me.”

Voice enabled system responds, “Okay. What condition is it in?”

Customer says, “It's in good condition”

Voice enabled system responds, “I have a Prime member family located a few blocks away that would love to have it. Should I give it to them?”

Customer says, “Yeah, let's do that. Set it up.”

Voice enabled system responds, “Great! This will make them very happy. I'll email you the details.” (the email will explain that they don't have to be present for the pick up and that they can just leave the table outside their home for pick up tomorrow morning. The email will ask if tomorrow morning is okay or if another time would be better.)

Alexa can trade it.

With Afterlife, Alexa can trade your used product for something you want that another Amazon Prime member bought on Amazon and is no longer using. It is possible to make this trade instant if the holder of the used item you want is waitlisted for a used product like yours or if they accept your proposed trade offer.

Alexa can donate it.

With Afterlife, Alexa can see if any local charitable organizations want your used item. She can make the necessary arrangements. She may be able to schedule a charitable pick up and provide you with a tax credit for the donation. Alexa will post your good deed to your Amazon profile and the recipient can post comments and photos of them putting your old product to good use if enabled. It is possible to make this donation instantly if the organization has registered or is waitlisted for such a product.

Alexa can recycle it.

With Afterlife, Alexa may be able to have the product removed for recycling or suggest recycling methods based on expert eco-warrior concepts and best practices. This depends on the product, your location and a number of other variables.

Alexa can repurpose it.

From time to time, depending on the product, a request may be made to collect certain products to be repurposed. For example: The company Terracycle might put in a request to Amazon to receive all used Toothbrushes for repurposing as bracelets. Or artistic projects may be looking to collect a certain used product for repurposing, in which case, Alexa can arrange for that with Afterlife.

Alexa can help dispose of it.

With Afterlife, Alexa can suggest best methods to dispose of the item based on product info and expert eco-warrior concepts and best practices. You don't need to know the local trash ordinances. (Example—How to best dispose of the KEYKO Genuine KT-670 6V 7Ah SLA Sealed Lead Acid Battery?) Alexa can also schedule a trash pick up. This service is especially helpful when moving or between your normally scheduled trash pick ups.

Alexa can help revive it.

With Afterlife, Alexa may be able to bring your old product back to life if it broke or is missing parts. Alexa knows everything about your product because Amazon sold it to you and she has access to all relevant manufacturer troubleshooting data and parts lists with many of these parts available for purchase directly on Amazon. She can also suggest common fixes found in consumer reviews and comments online. She can also call the product's manufacturer's customer support line with you on the line and tell them the model number and answer any other product questions they may have for you or she can submit an Incident Ticket on your behalf to have them contact you directly. She can rate the manufacturer on Amazon based on how well they help you. She can also check to see if you're product is still under warranty and may be able to arrange to have it repaired or replaced. She'll keep track of all the details. She will just handle it for you. You don't even need to know the model number. Lost the manual? Alexa can email it to you. Missing a part? Alexa can locate the part and sell it to you.

### EXAMPLE #8

Me: “Alexa, I lost the charge for my electric skateboard”

Alexa: “Not a problem, I can order a new one for you. The cost is $35.99. Is that okay?

Me: “Yes, please order that for me.”

In some cases, depending on the product and it's manufacturer, if the product did not last as long as expected or failed, Alexa may be able to get the manufacturer to buy it back from you or replace it even if the product is not under warranty. Some manufacturers are willing to buy it back so that they can study the damaged item in an effort learn what wrong so that they can make improvements. The buyback price may be lower than the initial sale price. But that is better than nothing in most cases.

### EXAMPLE #9

Me: “Alexa, My TV won't turn off.”

Alexa: “I will call Sony Customer service with you. Not to worry, I will tell them the model number and issue and help you figure this out. I know everything about your product including common issues and troubleshooting procedures. (she says this as she calls the Sony Customer service support line.) Hello, It's Alexa from Amazon. We sold a Bravia Sony TV Model #3290350234 to our friend Scott here. He is having trouble turning the tv off. Can you recommend a solution? . . . ”

Alexa can return it.

(This option is only available if within Amazon's return period)

### EXAMPLE #10

Customer: “Hey Alexa, Return the hose I just bought.”

Alexa: “Okay, why would you like to return it?”

Customer: “I don't need it.”

Alexa: “Okay, would you like me to send a printed return shipping label in the mail for a $1 fee? Or I can email you the return label for you to print, if you'd like.”

Customer: “Okay, yes, please send me the printed label in the mail.”

Alexa can lend it.

With Afterlife, if you are no longer using your product, but you may need it later and a local Prime Member is looking to borrow such a product, Alexa can lend the product out to the prime member, if you'd like to help. This is particularly useful in a state of emergency and/or a natural disaster or just an opportunity to practice the golden rule.

Alexa can rent it.

With Afterlife, if you are no longer using your product, but you may need it later and a local Prime Member is looking to rent such a product, Alexa can rent your product out to the prime member, if you'd like. Proceeds from the rental are credited directly to your Amazon account or they can be donated to the charity of your choice.

Alexa can pawn it.

If you'd like to buy something on Amazon but, you don't have enough money or Amazon credit to do so AND you have a product that you bought from Amazon, Amazon can lend you 30% of the used product's market value to put toward the purchase of the new Amazon product you want. You would send your used product to Amazon to hold for you for 1 month. If you pay back the loan within the one month timeframe, Amazon will send you back your used product. If the month passes and the loan is not paid, Amazon will keep the used product and resell it.

Old products lying around could help pay for your next Amazon purchase(s). Products that take up space that you don't use or need can go to someone who will use them. Products that you would otherwise throw in the trash, could be sold to someone who wants it. Products that you would otherwise throw in the trash, could be given to someone who will use them. Products that you would otherwise throw in the trash, could potentially be recycled or repurposed. Products that you would otherwise throw in the trash, might be put to better use or a better way to dispose of it may be available. Amazon stands to profit or benefit socially from every Afterlife transaction.

The system simplifies the experience by defining the products you bought from Amazon as My (Noun). For example, the system knows that for your account . . .

My TV=Sony Bravia Model No. 3049723594385 Manufactured Fall 2015 bought on Mar. 21, 2014

My Toaster=Badk'd Model No.: 3290873498 Style.0938432 bought on Apr. 21, 2012

My Table=Coavas Kitchen Dining Table White Round Coffee Table Modern Leisure Wooden Tea Table Office Conference Pedestal Desk Bought on Apr. 21, 2017

My Chairs=Winsome Wood Windsor Chair in Natural and White Finish, Set of 2 bought on Jan. 12, 2018

My Electric Skateboard=ACTON BLINK Lite V2|Summer Sale|World's Lightest Electric Skateboard for Youth|With LED Lights|Up To 5 Mile Range|10 MPH Top Speed|Bluetooth Remote Control Included bought on Jul. 12, 2018

My Guitar (1)=Martin Road Series DRS1 Dreadnought Acoustic-Electric Guitar Natural bought on Jul. 18, 2007

My Guitar (2)=Fender Standard Stratocaster Electric Guitar—Maple Fingerboard, Arctic White bought Sep. 28, 2017

Etc . . .

Typing in or clicking a multiple choice button to enter a used product condition description is not as telling as a verbally communicated condition description spoken directly into a microphone by the owner.

Once a sale is made, Alexa will send an email asking you to confirm the sale. The email will contain information about the sale including the amount of money that is immediately available for use from the sale.

Try the “Alexa, sell all my stuff” command. Great for moving or sorting out the Amazon bought belongings of someone who passed away. The system goes through all items and sells what it can sell and gives away what it can give away but can't sell and donates what it can donate and can't sell or giveaway and it recycles what it can recycle and can't sell, giveaway or donate. A confirmation is required to execute. A confirmation is sent by email. So, it sells it if it can. If it can't sell it and it can give it away, it gives it away. If it can't sell or give it away, it donates it. If it can't sell it, give it away or donate it, it recycles it. If it can't sell it, give it away, donate it or recycle it, it can arrange a pick for disposal by contacting and or contracting a local waste management service or by picking up the waste themselves. Amazon is a logistical dream. I think one day, Amazon will be in the Waste Management business. They might only offer waste management services to Amazon customers or Amazon Prime customers or only for Amazon bought items.

The “Tell me my options” command shall cause Alexa to say all of the available Afterlife Options in order. Customer can stop her at any time. Customer can ask Alexa which option is best or say “just do the best option” or “Just do what's best” and Alexa will initiate the option that the system deems best for most personal and social benefit.

An object of the present examples is to easily reference the products you bought from the electronic commerce company.

A further object of the present examples is to enable users to passively sell their used products instantly for the best available price at the time for when effortless speed is a priority over getting top dollar. Buyers line up to place buy orders because they stand to get a great deal, making it highly likelihood that there is a willing buyer at any given time. A minimum buy order price is set to avoid an unacceptably low sale price. This minimum buy order price can be adjusted if desired.

FIG. 11 illustrates a block diagram of an example machine 1100 upon which any one or more of the techniques (e.g., methodologies) discussed herein may perform. Examples, as described herein, may include, or may operate by, logic or a number of components, or mechanisms in the machine 1100. Circuitry (e.g., processing circuitry) is a collection of circuits implemented in tangible entities of the machine 1100 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, movable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1100 follow.

In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1100 may include a hardware processor 1102 (e.g., a central processing unit (CPU), a graphics processing unit (GPU), a hardware processor core, or any combination thereof), a main memory 1104, a static memory (e.g., memory or storage for firmware, microcode, a basic-input-output (BIOS), unified extensible firmware interface (UEFI), etc.) 1106, and mass storage 1108 (e.g., hard drive, tape drive, flash storage, or other block devices) some or all of which may communicate with each other via an interlink (e.g., bus) 1130. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1108, a signal generation device 1118 (e.g., a speaker), a network interface device 1120, and one or more sensors 1116, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1102, the main memory 1104, the static memory 1106, or the mass storage 1108 may be, or include, a machine readable medium 1122 on which is stored one or more sets of data structures or instructions 1124 (e.g., software) embodying or utilized by any one or more of the techniques or functions described herein. The instructions 1124 may also reside, completely or at least partially, within any of registers of the processor 1102, the main memory 1104, the static memory 1106, or the mass storage 1108 during execution thereof by the machine 1100. In an example, one or any combination of the hardware processor 1102, the main memory 1104, the static memory 1106, or the mass storage 1108 may constitute the machine readable media 1122. While the machine readable medium 1122 is illustrated as a single medium, the term “machine readable medium” may include a single medium or multiple media (e.g., a centralized or distributed database, and/or associated caches and servers) configured to store the one or more instructions 1124.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may be further transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A transmission medium is a machine readable medium.

### ADDITIONAL NOTES & EXAMPLES

Example 1 is a system for distributed inventory, the system comprising: processing circuitry; and a memory including instructions that, when the system is in operation, configure the system to: obtain information about an item in response to transfer of the item from a first location to a second location, the information obtained from a management system corresponding to the first location; receive a status change event for the item; update the information about the item based on the status change event; and transmit an instruction to enable moving the item from the second location to a third location based on the updated information about the item.

In Example 2, the subject matter of Example 1, wherein the management system corresponding to the first location is a retailer database.

In Example 3, the subject matter of Example 2, wherein the second location corresponds to a purchaser of the item.

In Example 4, the subject matter of any of Examples 1-3, wherein the status change event is an indication to sell the item.

In Example 5, the subject matter of Example 4, wherein the indication to sell the item is based on a voice command received at an intelligent microphone system.

In Example 6, the subject matter of any of Examples 4-5, wherein, to transmit an instruction to enable moving the item from the second location to a third location based on the updated information about the item, the instructions configure the processing circuitry to create a listing for the item in an electronic marketplace.

In Example 7, the subject matter of Example 6, wherein, to create the listing, the instructions configure the processing circuitry to: correlate the item with a class of items; calculate a market price for the item based on the class of items; and include the market price in the listing.

In Example 8, the subject matter of any of Examples 4-7, wherein the instructions further configure the processing circuitry to: request a condition assessment in response to receiving the status change event; and receive a characteristic of the item in response to the condition assessment, wherein updating the information about the item based on the status change event includes the characteristic.

In Example 9, the subject matter of Example 8, wherein, to request the condition assessment, the instructions configure the processing circuitry to provide instructions to capture at least one of an image or video of the item.

In Example 10, the subject matter of Example 9, wherein, to receive the characteristic of the item, the instructions configure the processing circuitry to: receive the image or video of the item; and invoke an inference engine on the image or video to produce the characteristic.

In Example 11, the subject matter of any of Examples 4-10, wherein the status change event includes an ambiguity, and wherein, to receive the status change event, the instructions configure the processing circuitry to: select an inquiry from a set of inquiries to resolve the ambiguity; transmit the inquiry to an author of the status change event; and update the status change event with an answer from the author to resolve the ambiguity.

In Example 12, the subject matter of Example 11, wherein the set of inquiries are voice prompts.

In Example 13, the subject matter of any of Examples 11-12, wherein, to select the set of inquiries, the instructions configure the processing circuitry to: retrieve a profile for a user of the item, the profile including a set of items of the user; collect characteristics of the set of items; calculate differentiating characteristics for the set of items by removing an intersection of characteristics between the set of items; and filter the set of inquiries to remove inquiries that are not directed to a differentiating characteristic.

In Example 14, the subject matter of any of Examples 1-13, wherein the item is a part in a second item.

In Example 15, the subject matter of any of Examples 1-14, wherein the status change event is notification that the item is an accessory item for a second item of a user, and wherein, to transmit the instruction to enable moving the item from the second location to a third location, the instructions configure the processing circuitry to transmit an offer to transfer the item to the user.

In Example 16, the subject matter of any of Examples 1-15, wherein the status change event is notification that the item has changed in value in a market, and wherein, to transmit the instruction to enable moving the item from the second location to a third location, the instructions configure the processing circuitry to transmit an offer to create a transaction for the user.

Example 17 is a system for asset control, the system comprising:

processing circuitry; a memory including instructions that, when the system is in operation, configure the processing circuitry to: record, in an order history, a sale of an asset to a first consumer, the sale conducted between the first consumer and a retailer, the first consumer registered with a retail platform of the retailer; present an asset list to the first consumer, the asset list based on the order history and including a list of assets purchased from the retailer by the first consumer and corresponding current value of each asset; receive an indication from the first consumer to transfer the asset; determine a set of transfer options for the asset; present the set of transfer options to the first consumer; receive a selected transfer option from the set of transfer options; and conduct a transaction based on the selected transfer option.

In Example 18, the subject matter of Example 17, wherein, to present the asset list, the instructions configure the processing circuitry to present the asset list in descending order of value.

In Example 19, the subject matter of any of Examples 17-18, wherein, to present the asset list, the instructions configure the processing circuitry to present the asset list based on market demand.

In Example 20, the subject matter of any of Examples 17-19, wherein the indication from the first consumer to transfer the asset is an indication to transfer ownership of the asset.

In Example 21, the subject matter of any of Examples 17-20, wherein the indication from the first consumer to transfer the asset is an indication to transfer physical control of the asset.

In Example 22, the subject matter of any of Examples 17-21, wherein, to determine a set of transfer options, the instructions configure the processing circuitry to: identify a current market demand of the asset; and determine the set of transfer options based on the current market demand.

In Example 23, the subject matter of any of Examples 17-22, wherein, to determine a set of transfer options, the instructions configure the processing circuitry to: identify a current condition of the asset; and determine the set of transfer options based on the current condition.

In Example 24, the subject matter of any of Examples 17-23, wherein, to present the set of transfer options to the first consumer, the instructions configure the processing circuitry to: present an option to sell, an option to donate, and an option to recycle the asset.

In Example 25, the subject matter of any of Examples 17-24, wherein, to receive the selected transfer option from the set of transfer options, the instructions configure the processing circuitry to: receive a verbal command from the first consumer; and analyze the verbal command.

In Example 26, the subject matter of any of Examples 17-25, wherein, to conduct the transaction based on the selected transfer option, the instructions configure the processing circuitry to: initiate a sale with a second consumer registered with the retail platform; and settle accounts of the first and second consumer based on the sale.

Example 27 is a method for distributed inventory, the method comprising: obtaining information about an item in response to transfer of the item from a first location to a second location, the information obtained from a management system corresponding to the first location; receiving a status change event for the item; updating the information about the item based on the status change event; and transmitting an instruction to enable moving the item from the second location to a third location based on the updated information about the item.

In Example 28, the subject matter of Example 27, wherein the management system corresponding to the first location is a retailer database.

In Example 29, the subject matter of Example 28, wherein the second location corresponds to a purchaser of the item.

In Example 30, the subject matter of any of Examples 27-29, wherein the status change event is an indication to sell the item.

In Example 31, the subject matter of Example 30, wherein the indication to sell the item is based on a voice command received at an intelligent microphone system.

In Example 32, the subject matter of any of Examples 30-31, wherein transmitting an instruction to enable moving the item from the second location to a third location based on the updated information about the item includes creating a listing for the item in an electronic marketplace.

In Example 33, the subject matter of Example 32, wherein creating the listing includes: correlating the item with a class of items; calculating a market price for the item based on the class of items; and including the market price in the listing.

In Example 34, the subject matter of any of Examples 30-33, comprising: requesting a condition assessment in response to receiving the status change event; and receiving a characteristic of the item in response to the condition assessment, wherein updating the information about the item based on the status change event includes the characteristic.

In Example 35, the subject matter of Example 34, wherein requesting the condition assessment includes providing instructions to capture at least one of an image or video of the item.

In Example 36, the subject matter of Example 35, wherein receiving the characteristic of the item includes: receiving the image or video of the item; and invoking an inference engine on the image or video to produce the characteristic.

In Example 37, the subject matter of any of Examples 30-36, wherein the status change event includes an ambiguity, and wherein receiving the status change event includes: selecting an inquiry from a set of inquiries to resolve the ambiguity; transmitting the inquiry to an author of the status change event; and updating the status change event with an answer from the author to resolve the ambiguity.

In Example 38, the subject matter of Example 37, wherein the set of inquiries are voice prompts.

In Example 39, the subject matter of any of Examples 37-38, wherein selecting the set of inquiries includes: retrieving a profile for a user of the item, the profile including a set of items of the user; collecting characteristics of the set of items; calculating differentiating characteristics for the set of items by removing an intersection of characteristics between the set of items; and filtering the set of inquiries to remove inquiries that are not directed to a differentiating characteristic.

In Example 40, the subject matter of any of Examples 27-39, wherein the item is a part in a second item.

In Example 41, the subject matter of any of Examples 27-40, wherein the status change event is notification that the item is an accessory item for a second item of a user, and wherein transmitting the instruction to enable moving the item from the second location to a third location includes transmitting an offer to transfer the item to the user.

In Example 42, the subject matter of any of Examples 27-41, wherein the status change event is notification that the item has changed in value in a market, and wherein transmitting the instruction to enable moving the item from the second location to a third location includes transmitting an offer to create a transaction for the user.

Example 43 is a method for asset control, the method comprising: recording, in an order history, a sale of an asset to a first consumer, the sale conducted between the first consumer and a retailer, the first consumer registered with a retail platform of the retailer; presenting an asset list to the first consumer, the asset list based on the order history and including a list of assets purchased from the retailer by the first consumer and corresponding current value of each asset; receiving an indication from the first consumer to transfer the asset; determining a set of transfer options for the asset; presenting the set of transfer options to the first consumer; receiving a selected transfer option from the set of transfer options; and conducting a transaction based on the selected transfer option.

In Example 44, the subject matter of Example 43, wherein presenting the asset list comprises presenting the asset list in descending order of value.

In Example 45, the subject matter of any of Examples 43-44, wherein presenting the asset list comprises presenting the asset list based on market demand.

In Example 46, the subject matter of any of Examples 43-45, wherein the indication from the first consumer to transfer the asset is an indication to transfer ownership of the asset.

In Example 47, the subject matter of any of Examples 43-46, wherein the indication from the first consumer to transfer the asset is an indication to transfer physical control of the asset.

In Example 48, the subject matter of any of Examples 43-47, wherein determining a set of transfer options comprises: identifying a current market demand of the asset; and determining the set of transfer options based on the current market demand.

In Example 49, the subject matter of any of Examples 43-48, wherein determining a set of transfer options comprises: identifying a current condition of the asset; and determining the set of transfer options based on the current condition.

In Example 50, the subject matter of any of Examples 43-49, wherein presenting the set of transfer options to the first consumer comprises: presenting an option to sell, an option to donate, and an option to recycle the asset.

In Example 51, the subject matter of any of Examples 43-50, wherein receiving the selected transfer option from the set of transfer options comprises: receiving a verbal command from the first consumer; and analyzing the verbal command.

In Example 52, the subject matter of any of Examples 43-51, wherein conducting the transaction based on the selected transfer option comprises: initiating a sale with a second consumer registered with the retail platform; and settling accounts of the first and second consumer based on the sale.

Example 53 is a non-transitory machine-readable medium including instructions for distributed inventory, the instructions, when executed by processing circuitry, cause the processing circuitry to perform operations comprising: obtaining information about an item in response to transfer of the item from a first location to a second location, the information obtained from a management system corresponding to the first location; receiving a status change event for the item; updating the information about the item based on the status change event; and transmitting an instruction to enable moving the item from the second location to a third location based on the updated information about the item.

In Example 54, the subject matter of Example 53, wherein the management system corresponding to the first location is a retailer database.

In Example 55, the subject matter of Example 54, wherein the second location corresponds to a purchaser of the item.

In Example 56, the subject matter of any of Examples 53-55, wherein the status change event is an indication to sell the item.

In Example 57, the subject matter of Example 56, wherein the indication to sell the item is based on a voice command received at an intelligent microphone system.

In Example 58, the subject matter of any of Examples 56-57, wherein transmitting an instruction to enable moving the item from the second location to a third location based on the updated information about the item includes creating a listing for the item in an electronic marketplace.

In Example 59, the subject matter of Example 58, wherein creating the listing includes: correlating the item with a class of items; calculating a market price for the item based on the class of items; and including the market price in the listing.

In Example 60, the subject matter of any of Examples 56-59, wherein the operations comprise: requesting a condition assessment in response to receiving the status change event; and receiving a characteristic of the item in response to the condition assessment, wherein updating the information about the item based on the status change event includes the characteristic.

In Example 61, the subject matter of Example 60, wherein requesting the condition assessment includes providing instructions to capture at least one of an image or video of the item.

In Example 62, the subject matter of Example 61, wherein receiving the characteristic of the item includes: receiving the image or video of the item; and invoking an inference engine on the image or video to produce the characteristic.

In Example 63, the subject matter of any of Examples 56-62, wherein the status change event includes an ambiguity, and wherein receiving the status change event includes: selecting an inquiry from a set of inquiries to resolve the ambiguity; transmitting the inquiry to an author of the status change event; and updating the status change event with an answer from the author to resolve the ambiguity.

In Example 64, the subject matter of Example 63, wherein the set of inquiries are voice prompts.

In Example 65, the subject matter of any of Examples 63-64, wherein selecting the set of inquiries includes: retrieving a profile for a user of the item, the profile including a set of items of the user; collecting characteristics of the set of items; calculating differentiating characteristics for the set of items by removing an intersection of characteristics between the set of items; and filtering the set of inquiries to remove inquiries that are not directed to a differentiating characteristic.

In Example 66, the subject matter of any of Examples 53-65, wherein the item is a part in a second item.

In Example 67, the subject matter of any of Examples 53-66, wherein the status change event is notification that the item is an accessory item for a second item of a user, and wherein transmitting the instruction to enable moving the item from the second location to a third location includes transmitting an offer to transfer the item to the user.

In Example 68, the subject matter of any of Examples 53-67, wherein the status change event is notification that the item has changed in value in a market, and wherein transmitting the instruction to enable moving the item from the second location to a third location includes transmitting an offer to create a transaction for the user.

Example 69 is a non-transitory machine-readable medium including instructions for asset control, the instructions, when executed by processing circuitry, cause the processing circuitry to perform operations comprising: recording, in an order history, a sale of an asset to a first consumer, the sale conducted between the first consumer and a retailer, the first consumer registered with a retail platform of the retailer; presenting an asset list to the first consumer, the asset list based on the order history and including a list of assets purchased from the retailer by the first consumer and corresponding current value of each asset; receiving an indication from the first consumer to transfer the asset; determining a set of transfer options for the asset; presenting the set of transfer options to the first consumer; receiving a selected transfer option from the set of transfer options; and conducting a transaction based on the selected transfer option.

In Example 70, the subject matter of Example 69, wherein presenting the asset list comprises presenting the asset list in descending order of value.

In Example 71, the subject matter of any of Examples 69-70, wherein presenting the asset list comprises presenting the asset list based on market demand.

In Example 72, the subject matter of any of Examples 69-71, wherein the indication from the first consumer to transfer the asset is an indication to transfer ownership of the asset.

In Example 73, the subject matter of any of Examples 69-72, wherein the indication from the first consumer to transfer the asset is an indication to transfer physical control of the asset.

In Example 74, the subject matter of any of Examples 69-73, wherein determining a set of transfer options comprises: identifying a current market demand of the asset; and determining the set of transfer options based on the current market demand.

In Example 75, the subject matter of any of Examples 69-74, wherein determining a set of transfer options comprises: identifying a current condition of the asset; and determining the set of transfer options based on the current condition.

In Example 76, the subject matter of any of Examples 69-75, wherein presenting the set of transfer options to the first consumer comprises: presenting an option to sell, an option to donate, and an option to recycle the asset.

In Example 77, the subject matter of any of Examples 69-76, wherein receiving the selected transfer option from the set of transfer options comprises: receiving a verbal command from the first consumer; and analyzing the verbal command.

In Example 78, the subject matter of any of Examples 69-77, wherein conducting the transaction based on the selected transfer option comprises: initiating a sale with a second consumer registered with the retail platform; and settling accounts of the first and second consumer based on the sale.

Example 79 is at least one machine-readable medium including instructions that, when executed by processing circuitry, cause the processing circuitry to perform operations to implement of any of Examples 1-78.

Example 80 is an apparatus comprising means to implement of any of Examples 1-78.

Example 81 is a system to implement of any of Examples 1-78.

Example 82 is a method to implement of any of Examples 1-78.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for asset control, the system comprising:
processing circuitry;
a memory including instructions that, when the system is in operation, configure the processing circuitry to:
record, in an order history, a sale of an asset to a first consumer, the sale conducted between the first consumer and a retailer, the first consumer registered with a retail platform of the retailer;
present an asset list to the first consumer, the asset list based on the order history and including a list of assets purchased from the retailer by the first consumer and corresponding current value of each asset;
receive an indication from the first consumer to transfer the asset;
determine a set of transfer options for the asset;
present the set of transfer options to the first consumer;
receive a selected transfer option from the set of transfer options; and
conduct a transaction based on the selected transfer option.

2. The system of claim 1, wherein, to present the asset list, the instructions configure the processing circuitry to present the asset list in descending order of value.

3. The system of claim 1, wherein, to present the asset list, the instructions configure the processing circuitry to present the asset list based on market demand.

4. The system of claim 1, wherein the indication from the first consumer to transfer the asset is an indication to transfer ownership of the asset.

5. The system of claim 1, wherein the indication from the first consumer to transfer the asset is an indication to transfer physical control of the asset.

6. The system of claim 1, wherein, to determine a set of transfer options, the instructions configure the processing circuitry to:
identify a current market demand of the asset; and
determine the set of transfer options based on the current market demand.

7. The system of claim 1, wherein, to determine a set of transfer options, the instructions configure the processing circuitry to:
identify a current condition of the asset; and
determine the set of transfer options based on the current condition.

8. The system of claim 1, wherein, to present the set of transfer options to the first consumer, the instructions configure the processing circuitry to:
present an option to sell, an option to donate, and an option to recycle the asset.

9. The system of claim 1, wherein, to receive the selected transfer option from the set of transfer options, the instructions configure the processing circuitry to:
receive a verbal command from the first consumer; and
analyze the verbal command.

10. The system of claim 1, wherein, to conduct the transaction based on the selected transfer option, the instructions configure the processing circuitry to:
initiate a sale with a second consumer registered with the retail platform; and
settle accounts of the first and second consumer based on the sale.

11. A method for asset control, the method comprising:
recording, in an order history, a sale of an asset to a first consumer, the sale conducted between the first consumer and a retailer, the first consumer registered with a retail platform of the retailer;
presenting an asset list to the first consumer, the asset list based on the order history and including a list of assets purchased from the retailer by the first consumer and corresponding current value of each asset;
receiving an indication from the first consumer to transfer the asset;
determining a set of transfer options for the asset;
presenting the set of transfer options to the first consumer;
receiving a selected transfer option from the set of transfer options; and
conducting a transaction based on the selected transfer option.

12. The method of claim 11, wherein presenting the asset list comprises presenting the asset list in descending order of value.

13. The method of claim 11, wherein presenting the asset list comprises presenting the asset list based on market demand.

14. The method of claim 11, wherein determining a set of transfer options comprises:
identifying a current market demand of the asset; and
determining the set of transfer options based on the current market demand.

15. The method of claim 11, wherein presenting the set of transfer options to the first consumer comprises:
presenting an option to sell, an option to donate, and an option to recycle the asset.

16. The method of claim 11, wherein receiving the selected transfer option from the set of transfer options comprises:
receiving a verbal command from the first consumer; and
analyzing the verbal command.

17. The method of claim 11, wherein conducting the transaction based on the selected transfer option comprises:
initiating a sale with a second consumer registered with the retail platform; and
settling accounts of the first and second consumer based on the sale.

18. A non-transitory machine-readable medium including instructions for asset control, the instructions, when executed by processing circuitry, cause the processing circuitry to perform operations comprising:
recording, in an order history, a sale of an asset to a first consumer, the sale conducted between the first consumer and a retailer, the first consumer registered with a retail platform of the retailer;
presenting an asset list to the first consumer, the asset list based on the order history and including a list of assets purchased from the retailer by the first consumer and corresponding current value of each asset;
receiving an indication from the first consumer to transfer the asset;
determining a set of transfer options for the asset;
presenting the set of transfer options to the first consumer;
receiving a selected transfer option from the set of transfer options; and
conducting a transaction based on the selected transfer option.

19. The non-transitory machine-readable medium of claim 18, wherein presenting the set of transfer options to the first consumer comprises:
presenting an option to sell, an option to donate, and an option to recycle the asset.

20. A system for distributed inventory, the system comprising:
processing circuitry; and
a memory including instructions that, when the system is in operation, configure the system to:
obtain information about an item in response to transfer of the item from a first location to a second location, the information obtained from a management system corresponding to the first location;
receive a status change event for the item;
update the information about the item based on the status change event; and
transmit an instruction to enable moving the item from the second location to a third location based on the updated information about the item.

21. The system of claim 20, wherein the management system corresponding to the first location is a retailer database.

22. The system of claim 21, wherein the second location corresponds to a purchaser of the item.

23. The system of claim 20, wherein the status change event is an indication to sell the item.

24. The system of claim 23, wherein the indication to sell the item is based on a voice command received at an intelligent microphone system.

25. The system of claim 23, wherein, to transmit an instruction to enable moving the item from the second location to a third location based on the updated information about the item, the instructions configure the processing circuitry to create a listing for the item in an electronic marketplace.

26. The system of claim 25., wherein, to create the listing, the instructions configure the processing circuitry to:
correlate the item with a class of items;
calculate a market price for the item based on the class of items; and
include the market price in the listing.

27. The system of claim 23, wherein the instructions further configure the processing circuitry to:
request a condition assessment in response to receiving the status change event; and
receive a characteristic of the item in response to the condition assessment, wherein updating the information about the item based on the status change event includes the characteristic.

28. The system of claim 27, wherein, to request the condition assessment, the instructions configure the processing circuitry to provide instructions to capture at least one of an image or video of the item.

29. The system of claim 28, wherein, to receive the characteristic of the item, the instructions configure the processing circuitry to:
receive the image or video of the item; and
invoke an inference engine on the image or video to produce the characteristic.

30. The system of claim 23, wherein the status change event includes an ambiguity, and wherein, to receive the status change event, the instructions configure the processing circuitry to:
select an inquiry from a set of inquiries to resolve the ambiguity;
transmit the inquiry to an author of the status change event; and
update the status change event with an answer from the author to resolve the ambiguity.

31. The system of claim 30, wherein the set of inquiries are voice prompts.

32. The system of claim 30, wherein, to select the set of inquiries, the instructions configure the processing circuitry to:
retrieve a profile for a user of the item, the profile including a set of items of the user;
collect characteristics of the set of items;
calculate differentiating characteristics for the set of items by removing an intersection of characteristics between the set of items; and
filter the set of inquiries to remove inquiries that are not directed to a differentiating characteristic.

33. The system of claim 20, wherein the item is a part in a second item.

34. The system of claim 20, wherein the status change event is notification that the item is an accessory item for a second item of a user, and wherein, to transmit the instruction to enable moving the item from the second location to a third location, the instructions configure the processing circuitry to transmit an offer to transfer the item to the user.

35. The system of claim 20, wherein the status change event is notification that the item has changed in value in a market, and wherein, to transmit the instruction to enable moving the item from the second location to a third location, the instructions configure the processing circuitry to transmit an offer to create a transaction for the user.
